(19) United States
(12) Patent Application Publication
(10) Pub. No.: US 2025/0385875 A1
(43) Pub. Date: Dec. 18, 2025

(54) ARTIFICIAL INTELLIGENCE-ENABLED REORDERING

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US)

(21) Appl. No.: 18/745,368

(22) Filed: Jun. 17, 2024

(51) Int. Cl. H04L 47/34; H04L 1/1812; H04L 1/1867; H04W 28/04

(52) U.S. Cl. CPC H04L 47/34; H04L 1/1812; H04L 1/1887; H04W 28/04

(57) ABSTRACT

Methods, systems, and devices for dynamically adjusting a reordering timer are described. A wireless device may receive control signaling indicating a configuration comprising a first set of one or more parameters associated with a reordering timer for a packet data convergence protocol (PDCP) entity of the wireless device, wherein the reordering timer is associated with reordering of a set of service data units (SDUs) by the PDCP entity of the wireless device. The wireless device may determine a duration for the reordering timer according to the first set of one or more parameters associated with the reordering timer, and the wireless device may forward one or more SDUs of the set of SDUs, based at least in part on an expiration of the reordering timer.

### FIELD OF TECHNOLOGY

The following relates to wireless communications, including artificial intelligence (AI)-enabled reordering.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

### SUMMARY

The described techniques relate to improved methods, systems, devices, and apparatuses that support artificial intelligence (AI)-enabled reordering. A method for wireless communications by a wireless device is described. The method may include receiving control signaling indicating a configuration including a first set of one or more parameters associated with a reordering timer for a packet data convergence protocol (PDCP) entity of the wireless device, and where the reordering timer is associated with reordering of a set of service data units (SDUs) by the PDCP entity of the wireless device, where at least one parameter of the first set of one or more parameters includes a set of multiple values, determining a duration for the reordering timer according to the first set of one or more parameters associated with the reordering timer and based on a loss of at least one SDU of the set of SDUs, where the duration corresponds a value of the set of multiple values, and forwarding one or more SDUs of the set of SDUs based on an expiration of the reordering timer.

A wireless device for wireless communications is described. The wireless device may include one or more memories storing processor executable code, and one or more processors coupled with the one or more memories. The one or more processors may individually or collectively be operable to execute the code to cause the wireless device to receive control signaling indicating a configuration including a first set of one or more parameters associated with a reordering timer for a PDCP entity of the wireless device, and where the reordering timer is associated with reordering of a set of SDUs by the PDCP entity of the wireless device, where at least one parameter of the first set of one or more parameters includes a set of multiple values, determine a duration for the reordering timer according to the first set of one or more parameters associated with the reordering timer and based on a loss of at least one SDU of the set of SDUs, where the duration corresponds a value of the set of multiple values, and forwarding one or more SDUs of the set of SDUs based on a expiration of the reordering timer.

Another wireless device for wireless communications is described. The wireless device may include means for receiving control signaling indicating a configuration including a first set of one or more parameters associated with a reordering timer for a PDCP entity of the wireless device, and where the reordering timer is associated with reordering of a set of SDUs by the PDCP entity of the wireless device, where at least one parameter of the first set of one or more parameters includes a set of multiple values, means for determining a duration for the reordering timer according to the first set of one or more parameters associated with the reordering timer and based on a loss of at least one SDU of the set of SDUs, where the duration corresponds a value of the set of multiple values, and means for forwarding one or more SDUs of the set of SDUs based on an expiration of the reordering timer.

A non-transitory computer-readable medium storing code for wireless communications is described. The code may include instructions executable by one or more processors to receive control signaling indicating a configuration including a first set of one or more parameters associated with a reordering timer for a PDCP entity of the wireless device, and where the reordering timer is associated with reordering of a set of SDUs by the PDCP entity of the wireless device, where at least one parameter of the first set of one or more parameters includes a set of multiple values, determine a duration for the reordering timer according to the first set of one or more parameters associated with the reordering timer and based on a loss of at least one SDU of the set of SDUs, where the duration corresponds a value of the set of multiple values, and forward one or more SDUs of the set of SDUs based on an expiration of the reordering timer.

Some examples of the method, wireless devices, and non-transitory computer-readable medium described herein may further include operations, features, means, or instructions for determining the duration for the reordering timer according to a learning model associated with the PDCP entity of the wireless device, where an input to the learning model includes one or more of the first set of one or more parameters or a second set of one or more parameters, where a value of the duration for the reordering timer includes an output of the learning model.

Some examples of the method, wireless devices, and non-transitory computer-readable medium described herein may further include operations, features, means, or instructions for transmitting, to a second wireless device, a radio resource control message including an indication of the determined duration for the reordering timer according to the learning model, where the radio resource control message includes assistance information, and where the assistance information includes the indication of the determined duration for the reordering timer according to the learning model, transmitting, to the second wireless device, a medium access control-control element including the indication of the determined duration for the reordering timer according to the learning model, transmitting, to the second wireless device, a control protocol data unit (PDU) including the indication of the determined duration for the reordering timer according to the learning model, transmitting, to the second wireless device, a PDCP in-band signal including the indication of the determined duration for the reordering timer according to the learning model, and where the second wireless device include a UE or a network entity, including a base station or a server associated with the learning model.

Some examples of the method, wireless devices, and non-transitory computer-readable medium described herein may further include operations, features, means, or instructions for generating at least one PDU including an indication of the determined duration for the reordering timer according to the learning model and outputting, to a second wireless device via the PDCP entity of the wireless device, the at least one PDU including the indication of the determined duration for the reordering timer according to the learning model, where the at least one PDU includes a PDCP data PDU or a PDCP control PDU, and where the second wireless device include a UE or a network entity, including a base station or a server associated with the learning model.

Some examples of the method, wireless devices, and non-transitory computer-readable medium described herein may further include operations, features, means, or instructions for receiving, from a second wireless device, hybrid automatic repeat request (HARQ) feedback, where the HARQ feedback includes at least one acknowledgment (ACK) or negative acknowledgment (NACK) associated with the determined duration for the reordering timer according to the learning model, where the second wireless device include a UE or a network entity, including a base station or a server associated with the learning model.

Some examples of the method, wireless devices, and non-transitory computer-readable medium described herein may further include operations, features, means, or instructions for storing a set of one or more logs associated with the learning model, where at least one log of the set of one or more logs includes a set of previous durations of the reordering timer, where the input to the learning model includes the set of previous durations of the reordering timer, where determining the duration for the reordering timer according to the learning model may be based on the input to the learning model includes the set of previous durations of the reordering timer.

Some examples of the method, wireless devices, and non-transitory computer-readable medium described herein may further include operations, features, means, or instructions for transmitting, to a second wireless device, a report including the set of one or more logs associated with the learning model, where at least one second log of the set of one or more logs associated with the learning model includes a set of performance metrics associated with the learning model for the set of previous durations of the reordering timer, where the second wireless device include a UE or a network entity, including a base station or a server associated with the learning model.

Some examples of the method, wireless devices, and non-transitory computer-readable medium described herein may further include operations, features, means, or instructions for transmitting, to a second wireless device, a report including capability information that indicates whether the wireless device supports a learning model associated with the reordering timer for the PDCP entity of the wireless device, a quality metric associated with the learning model, or both, where the capability information further indicates whether the wireless device supports one or more of prediction of a set of arrival times of the set of SDUs according to the learning model or reporting of an accuracy of the learning model for the prediction of the set of arrival times of the set of SDUs, where the second wireless device include a UE or a network entity, including a base station or a server associated with the learning model, where receiving the control signaling indicating the configuration including the first set of one or more parameters associated with the reordering timer for the PDCP entity of the wireless device may be based on the capability information.

In some examples of the method, wireless devices, and non-transitory computer-readable medium described herein, and the method, apparatuses, and non-transitory computer-readable medium may include further operations, features, means, or instructions for at least one first parameter that indicates a first threshold value associated with the reordering timer, at least one second parameter that indicates a second threshold value associated with the reordering timer, at least one third parameter that indicates a threshold quantity of SDUs of the set of SDUs allowed for forwarding by the PDCP entity of the wireless device, at least one fourth parameter that indicates whether the reordering timer may be configurable for counting the threshold quantity of SDUs of the set of SDUs allowed for forwarding by the PDCP entity of the wireless device, at least one fifth parameter that indicates whether a learning model may be enabled or disabled for the PDCP entity of the wireless device, or at least one sixth parameter that indicates whether reordering of the set of SDUs may be based on a QoS flow and whether the learning model may be enabled or disabled for the QoS flow.

In some examples of the method, wireless devices, and non-transitory computer-readable medium described herein, the configuration may be associated with one or more of a QoS flow, a primary cell associated with the wireless device, a secondary cell associated with the wireless device, a logical channel associated with the PDCP entity of the wireless device, or a component carrier associated with the wireless device.

In some examples of the method, wireless devices, and non-transitory computer-readable medium described herein, the configuration includes a second set of one or more parameters associated with a learning model associated with the reordering timer for the PDCP entity of the wireless device and a performance target of the learning model may be based on the second set of one or more parameters.

Some examples of the method, wireless devices, and non-transitory computer-readable medium described herein may further include operations, features, means, or instructions for determining a failure of the learning model to satisfy at least one parameter of the second set of one or more parameters and updating the duration of the reordering timer according to the at least one parameter that indicates a second threshold value associated with the reordering timer, based on the failure of the learning model to satisfy the at least one parameter of the second set of one or more parameters.

Some examples of the method, wireless devices, and non-transitory computer-readable medium described herein may further include operations, features, means, or instructions for transmitting, to a second wireless device, a report including an indication of a performance of the learning model to satisfy at least one parameter of the second set of one or more parameters, where the second wireless device include a network entity, including a base station or a server associated with the learning model and disabling the learning model based on the failure of the learning model to satisfy at least one parameter of the second set of one or more parameters.

Some examples of the method, wireless devices, and non-transitory computer-readable medium described herein may further include operations, features, means, or instructions for receiving, from a second wireless device, a report including an indication of a performance of the learning model, where the second wireless device include a network entity, including a base station or a server associated with the learning model.

### BRIEF DESCRIPTION OF THE DRAWINGS

FIGS. 1 and 2 show examples of a wireless communications system that supports artificial intelligence (AI)-enabled reordering in accordance with one or more aspects of the present disclosure.

FIG. 3 shows an example of a ML architecture that supports AI-enabled reordering in accordance with one or more aspects of the present disclosure.

FIGS. 4 and 5 show an example of a block diagrams of a user equipment (UE) that support AI-enabled reordering in accordance with one or more aspects of the present disclosure.

FIGS. 6 through 12 show examples of process flows that support AI-enabled reordering in accordance with one or more aspects of the present disclosure.

FIG. 13 is an illustrative block diagram of an example ML architecture that may be used for wireless communications in accordance with one or more aspects of the present disclosure.

FIGS. 14 and 15 show block diagrams of devices that support AI-enabled reordering in accordance with one or more aspects of the present disclosure.

FIG. 16 shows a block diagram of a communications manager that supports AI-enabled reordering in accordance with one or more aspects of the present disclosure.

FIG. 17 shows a diagram of a system including a UE that supports AI-enabled reordering in accordance with one or more aspects of the present disclosure.

FIG. 18 shows a diagram of a system including a network entity that supports AI-enabled reordering in accordance with one or more aspects of the present disclosure.

FIG. 19 shows a flowchart illustrating a method that supports AI-enabled reordering in accordance with one or more aspects of the present disclosure.

### DETAILED DESCRIPTION

A wireless device may be equipped with a protocol stack to support various functionalities associated with wireless communication. The protocol stack may include various protocol layers. One example of a protocol layer includes a radio link control (RLC) layer (also referred to as an RLC entity herein). The RLC layer may perform transfer of upper layer protocol data units (PDUs) according to one or more modes, including: an acknowledged mode (AM), an unacknowledged mode (UM), and a transparent mode (TM). The RLC layer may be referred to as a TM RLC entity, a UM RLC entity, or an AM RLC entity based on a configured mode of data transfer for the RLC entity. The RLC layer may receive an RLC data PDU from and/or transmit to upper protocol layers of the protocol stack of the wireless device. Another example of a protocol layer may include a packet data convergence protocol (PDCP) layer (also referred to as a PDCP entity herein) of the wireless device.

The wireless device may detect a packet gap due to one or more missing packets, and a PDCP entity of the wireless device may initiate a packet reordering procedure. For example, the PDCP entity of the wireless device may initiate a reordering timer (e.g., outlining a reordering window duration), during which the PDCP entity of the wireless device may wait to receive the one or more missing packets and perform reordering as the packets arrive. The wireless device may be delaying the forwarding of the packets that have arrived while waiting for the reordering timer to expire, however this may cause an increase in power and memory usage, especially if the reordering timer is relatively long. Additionally, the delaying of the forwarding of the packets may be unnecessary if the one or more missing packets do not arrive or arrive too late to be useful. Conversely, if the reordering timer is relatively short, the wireless device may be forwarding too many packets out of order before the missing packets arrive, which may reduce transmission throughput. In many cases, the reordering timer may be a fixed duration, however, regardless of conditions experienced by the wireless device. As such, techniques for adjusting the reordering window based on the conditions experienced by the wireless device may be beneficial to improve transmission throughput and reduce power and memory usage.

In accordance with examples as described herein, the wireless device may adjust a duration for the reordering window based on one or more learning models (e.g., an artificial intelligence (AI)/machine learning (ML) model). For example, the wireless device may input data associated with arrival times for packets (e.g., for all packets, or only missing packets) to the one or more learning models to predict packet arrival times. The one or more learning models may determine a predicted duration for the reordering timer (e.g., an optimal duration), which may be used by the wireless device to perform reordering procedures. In some cases, the wireless device may input a difference between the predicted duration for the reordering timer and the actual arrival duration of missing packets to the one or more learning models, which may be used to further improve the predictions of the one or more learning models. Accordingly, the wireless device may adjust the duration of the reordering timer based on arrival times from packets, which may improve communication performance and throughput, and reduce unnecessary wait times for packet forwarding.

Aspects of the disclosure are initially described in the context of wireless communications systems. Aspects of the disclosure are additionally described with respect to ML architectures, block diagrams, and process flows relating to using ML models for AI-enabled reordering. Aspects of the disclosure are further illustrated by and described with reference to apparatus diagrams, system diagrams, and flowcharts that relate to AI-enabled reordering.

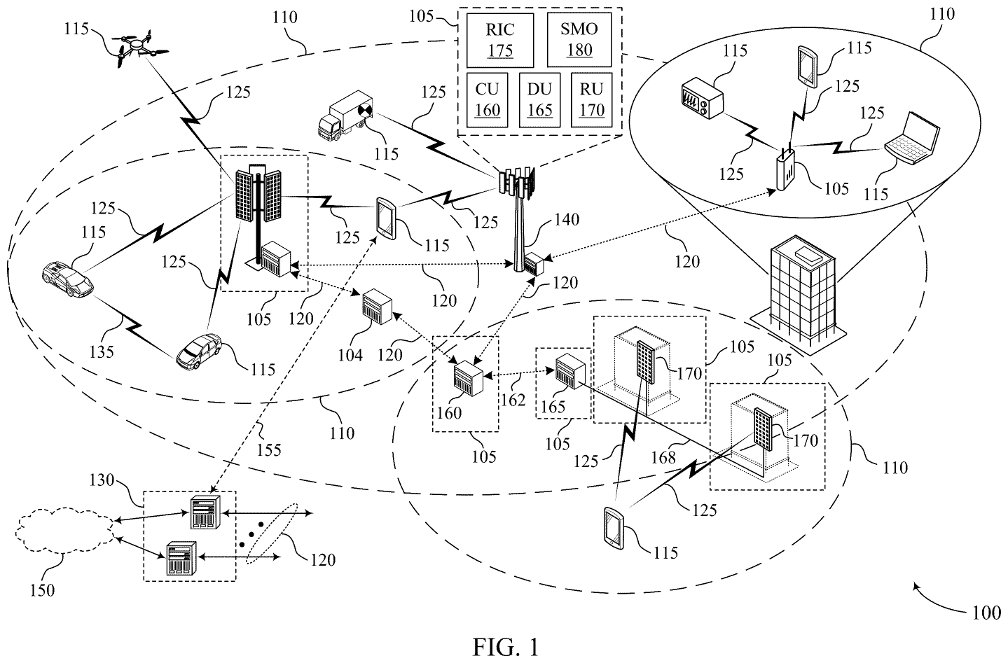

FIG. 1 shows an example of a wireless communications system 100 that supports AI-enabled reordering in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

A wireless device, such as a UE 115 or a network entity 105, may receive one or more packets (e.g., PDCP protocol data units (PDUs), PDCP service data units (SDUs)) via a PDCP entity from another device or another layer in the protocol stack. A PDCP entity of the wireless device, for example, may process the received packets, and may forward the packets to another layer in the protocol stack (e.g., an RLC layer for downlink packets, an IP layer for uplink packets). In some cases, the wireless device may detect a gap (e.g., a PDCP gap) in one or more received packets. For instance, the wireless device (e.g., via the PDCP entity) may determine that a packet is missing, for example, based on a sequence number associated with received packets (e.g., being out of order).

After detecting a missing packet, the wireless device may initiate a packet reordering procedure. For example, the wireless device may initiate a reordering timer, during which the wireless device may wait to receive the one or more missing packets and perform reordering as the packets arrive. The PDCP entity of the wireless device may delay the forwarding of the packets that have arrived (e.g., to another layer in the protocol stack) while waiting for the reordering timer to expire, however, which may cause an increase in power and memory usage, especially if the reordering timer is relatively long. Additionally, the delaying of the forwarding of the packets may be unnecessary if the one or more missing packets do not arrive or arrive too late to be useful. Conversely, if the reordering timer is relatively short, the PDCP entity may be forward too many packets out of order before the missing packets arrive, which may reduce transmission throughput.

In accordance with examples as described herein, a wireless device may adjust a duration for the reordering window based on conditions experienced by the wireless device. For example, the wireless device may input data associated with arrival times for packets (e.g., for all packets, or only missing packets) to one or more ML models to predict packet arrival times. The one or more ML models may determine a predicted duration for the reordering timer (e.g., an optimal duration), which may be used by the UE to perform reordering procedures. In some cases, the UE may input a difference between the predicted duration for the reordering timer and the actual arrival duration of missing packets to the one or more ML models, which may be used to further improve the predictions of the one or more ML models. In some examples, the wireless device may receive a configuration that may indicate a limit duration for the reordering timer, and the wireless device may select the duration for the reordering timer in accordance with the limit duration. Additionally, or alternatively, the wireless device may be configured with a set of key performance indicators (KPIs), which may be used by the wireless device or a network entity 105 to evaluate the performance of the one or more ML models. Accordingly, the wireless device may adjust a duration for the reordering timer, thereby improving throughput, reducing a quantity of packets forwarded out of order, or both, depending on communication conditions experienced by the wireless device.

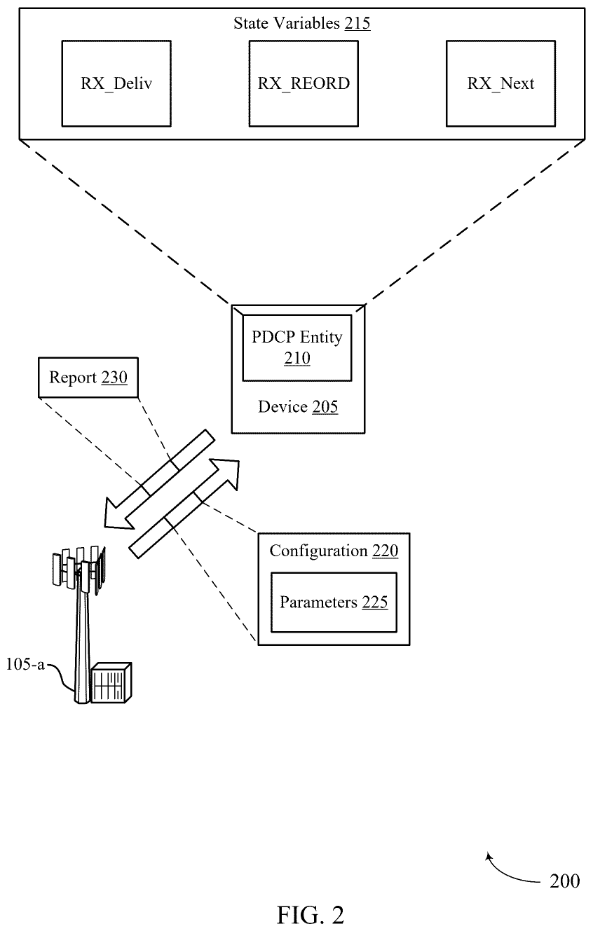

FIG. 2 shows an example of a wireless communications system 200 that supports AI-enabled reordering in accordance with one or more aspects of the present disclosure. The wireless communications system 200 shows wireless communications between a network entity 105-a and a device 205. In some examples, the device 205 may be another network entity 105, a UE 115, or a base station 140 as described herein.

The device 205 may receive one or more packets (e.g., PDCP SDUs) from the network entity 105-a. In some examples, a PDCP entity 210 of the device 205 may process the received packets and may forward (e.g., transfer or transmit) the packets to another protocol layer in a protocol stack of the device 205 (e.g., an RLC layer for downlink packets, an IP layer for uplink packets). While the device 205 is illustrated with a single PDCP entity 210, the device 205 may have multiple PDCP entities that individually or collectively perform the operations, functions, and the like as described herein.

The device 205 may detect a gap (e.g., a PDCP gap, via the PDCP entity 210 of the device 205) in one or more received packets. In some examples, the device 205 (e.g., via the PDCP entity 210 of the device 205) may detect a gap in one or more received packets upon determining that a packet is missing based on one or more sequence numbers (SNs) associated with received packets. For example, the device 205 including the PDCP entity 210 may determine that an SN associated with a packet is out of order from an SN associated with a previous packet. For instance, the device 205 including the PDCP entity 210 may receive a packet with a SN of four (e.g., SN=4), and subsequently receive a packet with an SN of six (e.g., SN=6) when an SN of five (e.g., SN=5) was expected by the device 205 including the PDCP entity 210. The device 205 including the PDCP entity 210 may initiate a reordering procedure, which may involve initiating a reordering timer (e.g., t-reordering).

During the reordering procedure, the device 205 including the PDCP entity 210 may await missing packets (e.g., a packet with a SN of five, in the previous example). In some examples, the device 205 including the PDCP entity 210 may update state variables 215 (also referred to as PDCP state variables or parameters) during the reordering procedure. For example, the device 205 including the PDCP entity 210 may update a state variable RX_Deliv to indicate (e.g., via a corresponding SN) a first packet that has not been forwarded (e.g., to another protocol layer of the device 205), while any packets preceding RX-Deliv may have been forwarded (e.g., to another layer in the protocol stack of the device 205). The packet corresponding to RX_Deliv and any packets that are subsequent to the packet corresponding to RX_Deliv may be buffered at the device 205 including the PDCP entity 210, but will be undelivered until each of the one or more missing packets is received, or until the reordering timer expires.

The state variable RX_REORD may indicate (e.g., via a corresponding SN) a packet that triggered the reordering procedure. For example, RX_Deliv may correspond to the SN of a first packet that has not been received by the device 205 including the PDCP entity 210, and RX_REORD may correspond to a second packet that was most recently received. In some examples, there may be one or more additional missing packets between the first packet and the second packet. The state variable RX_Next may correspond to (e.g., a SN corresponding to) a next packet that is expected to be received.

If the device 205 including the PDCP entity 210 receives each of the one or more missing packets prior to the packet corresponding to RX_REORD, the device 205 including the PDCP entity 210 may forward, in the correct order, all undelivered packets. For example, the device 205 including the PDCP entity 210 may forward the packet corresponding to RX_Deliv, the packet corresponding to RX_REORD, and any packets in between (e.g., to another protocol layer or entity of the device 205). If the device 205 does not receive all of the one or more missing packets, the device 205 including the PDCP entity 210 may forward all of the packets that were received (e.g., with at least one missing packet). The device 205 including the PDCP entity 210 may update RX_REORD to correspond to the packet that was indicated by RX_Next. If there is another missing packet detected, RX_Deliv would be updated accordingly to correspond to the SN for the missing packet, and the reordering timer may be initiated again.

In some cases, the reordering timer (e.g., t-reordering) may be a static parameter configured for the device 205 (e.g., by the network entity 105-a), and may not change based on any conditions experienced by the device 205. In these cases, if the configured duration for the reordering timer is too large, the device 205 including the PDCP entity 210 may be delaying the forwarding of too many packets unnecessarily, even if the missing packets are not arriving or are arriving too late to be useful. The large reordering timer duration may also be associated with increased memory and power consumption. Conversely, if the configured duration for the reordering timer is too short, the device 205 including the PDCP entity 210 may be forwarding too many packets out of order, which can be detrimental to throughput (e.g., transmission control protocol (TCP) throughput). Accordingly, it may be beneficial for the device 205 to be capable of dynamically adjusting the reordering timer duration.

In accordance with examples as described herein, the device 205 including the PDCP entity 210 may dynamically control a value for the reordering timer (e.g., for a reordering window duration). In some examples, the device 205 including the PDCP entity 210 may adjust a duration for the reordering timer based on a configuration 220 (e.g., an RRC configuration). The network entity 105-a may transmit control signaling that indicates the configuration 220, which may include one or more parameters 225 (e.g., information elements) associated with the reordering timer for the PDCP entity 210. In some examples, the configuration 220 may be defined per quality-of-service (QOS) flow, per main node or secondary node, or per serving cell (e.g., per component carrier).

In some examples, one of the parameters 225 may indicate an upper limit duration (e.g., a Max-t-reordering field) for the reordering timer (e.g., as a first threshold value), a lower limit duration (e.g., a Min-t-reordering field) for the reordering timer (e.g., as a second threshold value), a threshold quantity of packets (e.g., of SDUs) that may be allowed to be delivered out of order by the PDCP entity 210 (e.g., a Max-early-out-of-order-allowed field), a threshold duration (e.g., an Out-of-order_timer field) for counting the quantity of packets that may be allowed to be delivered out of order (e.g., the quantity of packets that may be delivered out of order are counted in a rolling window according to the threshold duration), or a combination thereof.

The device 205 including the PDCP entity 210 may adjust the reordering timer based on the configuration 220 and the parameters 225. For example, the device 205 including the PDCP entity 210 may select a duration for the reordering timer that is within the upper limit and the lower limit indicated by the one or more parameters 225. Additionally, or alternatively, the device 205 including the PDCP entity 210 may extend or shorten the duration for the reordering timer based on a quantity of packets that would be delivered out of order. For example, if the quantity of packets that are out of order exceeds the threshold quantity of packets indicated by the one or more parameters 225, the device 205 including the PDCP entity 210 may extend the duration for the reordering timer. Alternatively, if the quantity of packets that are out of order is below (e.g., more than a threshold amount) the threshold quantity of packets indicated by the one or more one or more parameters 225, the device 205 including the PDCP entity 210 may shorten the duration for the reordering timer.

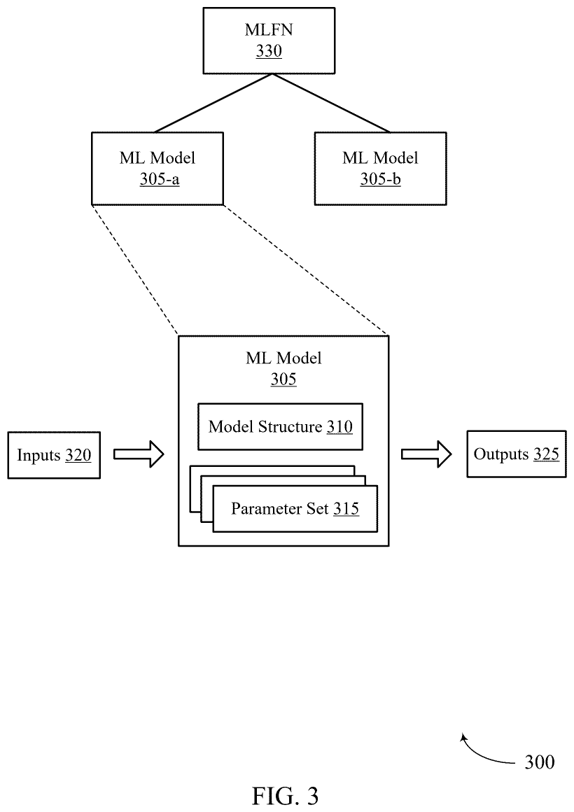

In some examples, the device 205 including the PDCP entity 210 may use learning techniques (e.g., AI techniques) to adjust the duration of the reordering timer. In some examples, the device 205 including the PDCP entity 210 may input a range for the duration of the reordering timer, which may be based on the parameters 225 (e.g., the upper limit and the lower limit) received from the network entity 105-a. The device 205 including the PDCP entity 210 may use one or more learning models (e.g., AI/ML models) to predict the duration for the reordering timer. For example, the device 205 including the PDCP entity 210 may input data associated with arrival times for packets (e.g., for all packets, or only missing packets) to the one or more learning models to predict packet arrival times. The one or more learning models may determine a predicted duration for the reordering timer (e.g., an optimal duration), which may be used by the device 205 including the PDCP entity 210 to perform reordering procedures. In some examples, the one or more learning models may be operated at the device 205, at the network entity 105-a, at a server (e.g., an AI/ML server), or a combination thereof. Details regarding the implementation of the one or more ML models are described herein with reference to FIGS. 3 through 12.

In some examples, the device 205 including the PDCP entity 210 may use one or more key performance indicators (KPIs) to evaluate or define the performance of the one or more learning models in predicting the duration for the reordering timer. For example, a KPI may be associated with defining a quantity of packets that the device 205 is allowed to deliver out of order before expiration of the upper limit duration for the reordering timer. Additionally, or alternatively, a KPI may define a percentage tolerance of packets that may be delivered out of order. In one nonlimiting example, the KPI may indicate that 95% of packets are to be delivered in order, thereby allowing a tolerance of 5% of packets that may be delivered out of order by the device 205 including the PDCP entity 210. In some cases, the device 205 may input a difference between the predicted duration for the reordering timer and the actual arrival duration of missing packets to the one or more learning models, which may be used to further improve the predictions of the one or more learning models. For example, the device 205 including the PDCP entity 210 may use an accuracy prediction KPI, which may be updated based on the difference between the predicted arrival time of a missing packet and the actual arrival time of the missing packet. For instance, if one or more missing packets arrive shortly after expiration of the reordering timer, the accuracy prediction KPI may be updated, which may cause the one or more learning models to extend the duration of the reordering timer.

In some examples, the device 205 may be configured with a KPI that assesses the predictive accuracy of the one or more learning models (e.g., via the configuration 220). For example, the KPI may set a target accuracy for the learning models. In some cases, the device 205 may be unable to maintain the KPI. For example, the device 205 may determine that the duration for the reordering timer is too small, for instance, based on packets arriving after the predicted duration but before the upper limit duration. In some cases, the device 205 including the PDCP entity 210 may set the duration for the reordering timer to the upper limit duration for a configured duration after determining that the KPI is not met. After the configured duration, the device 205 may use the learning models again to attempt to reduce the duration of the reordering timer. Alternatively, the device 205 may disable the use of the one or more learning models for adjusting the duration for the reordering timer (e.g., until re-enabled by the network entity 105-a). In some cases, the device 205 may transmit a KPI violation report to the network entity 105-a or to a server hosting the one or more learning models, if the device 205 is unable to meet the KPI.

In some examples, the prediction for the duration of the reordering timer may be based on a probability distribution (e.g., associated with a probability of arrival times for missing packets). Accordingly, the device 205 including the PDCP entity 210 may dynamically adjust the duration for the reordering timer, which may improve the processing of packets by the device 205 including the PDCP entity 210. In some examples, the device 205 may use the learning techniques for predicting the duration of the reordering timer based on one or more conditions. For example, the parameters 225 may include a parameter that indicates whether learning techniques (e.g., AI techniques) are allowed or enabled to be used for adjusting the reordering timer duration (e.g., via an AIML_Allowed field). Additionally, or alternatively, the parameters 225 may include a parameter that indicates whether reordering the packets by the device 205 including the PDCP entity 210 is based on a QoS flow, or may indicate a QoS flow associated with the configuration 220, and the learning techniques may be used by the device 205 based on the QoS flow. For example, there may be a parameter 225 that indicates whether the learning techniques are enabled for the QoS flow.

In some examples, the device 205 (e.g., in aspects where the device 205 is a UE 115) may transmit a report 230 to the network entity 105-a based on updating the duration of the reordering timer. For example, the report 230 may indicate the selected duration (e.g., the optimal duration) for the reordering timer (e.g., the t-reordering value). In some cases, the report 230 may be transmitted via an RRC message, a PDCP data PDU, a PDCP control PDU, a PDCP in-band signal, a MAC-control element (MAC-CE), or a combination thereof. In some cases, the report 230 may indicate that the device 205 has updated the reordering timer to the predicted duration. Additionally, or alternatively, the report 230 may request the network entity 105-a to configure the reordering timer in accordance with the predicted duration indicated in the report 230.

In the examples where the report 230 is transmitted by the device 205 to request the network entity 105-a to reconfigure the reordering timer, the report 230 may be transmitted via an RRC message (e.g., via UE assistance information), or via a PDCP data or control PDU, for example. In some cases, the network entity 105-a may respond to the request via a MAC-CE, which may include an acknowledgment (ACK) or a negative acknowledgment (NACK) to indicate whether the recommended duration indicated in the report 230 is accepted or denied. Additionally, or alternatively, the network entity 105-a may perform a PDCP reconfiguration to reconfigure the duration for the reordering timer.

In some examples, the device 205 may indicate information associated with the one or more learning models in the report 230 (e.g., or a separate report 230). For example, the device 205 may indicate metadata, timestamps, or other information associated with the one or more learning models to the network entity 105-a. In some examples, the information may be indicated as one or more information elements. Additionally, or alternatively, the device 205 may report performance of the one or more learning models via a report 230, which may be based on a performance target (e.g., configured via the one or more parameters 225). For example, the device 205 may report a prediction accuracy for the arrival time for missing packets predicted by the one or more learning models, or the device 205 may report the actual arrival time predicted by the one or more learning models. Accordingly, the network entity 105-a may evaluate the performance of the one or more learning models. In some examples, the network entity 105-a may issue an updated configuration 220 based on the report 230, or may entirely disable the use of the one or more learning models (e.g., via one or more parameters 225) based on the performance falling below the target performance (e.g., for some duration of time).

In some cases, the network entity 105-a may monitor one or more KPIs for the one or more learning models of the device 205 based on the information transmitted by the device 205 (e.g., via one or more reports 230). For example, the network entity 105-a may transmit signaling that indicates which of the one or more KPIs are being satisfied, or may indicate a quantity of the total KPIs that are being satisfied by the one or more learning models. The device 205 may use the indication from the network entity 105-a to adjust the operations of the one or more learning models. For instance, the device 205 may adjust parameters for the one or more learning models, or may disable the use of the one or more learning models (e.g., at least for a threshold duration) based on the quantity of KPIs that are being satisfied (e.g., or that are not being satisfied).

Accordingly, the device 205 may adjust the duration for the reordering timer using one or more learning models, which may improve the functioning of the device 205 including the PDCP entity 210, thereby reducing power and memory consumption, and improving throughput associated with the protocol layers of the device 205.

FIG. 3 shows an example of a ML architecture 300 that supports AI-enabled reordering in accordance with one or more aspects of the present disclosure. The ML architecture 300 illustrates an implementation for an ML model 305 (e.g., an AI model), which may be used to perform one or more features described herein. The ML model 305 may generate a set of one or more outputs 325 based on a set of one or more inputs 320. For example, the ML model 305 may be a data driven model (e.g., algorithm), which uses learning techniques (e.g., AI techniques) to generate the outputs 325. In some cases, the ML model 305 may be described using a model structure 310. For example, the ML model 305 may include one or more computation graphs, and the model structure 310 may define a structure for the ML model 305 for generating the outputs 325.

The ML model 305 may include one or more parameter sets 315. The parameter sets 315 may be neural network weights, for example, which may be used in combination with the model structure 310 to generate the outputs 325. In some examples, the ML model 305 (e.g., alone or in combination with other ML models 305) may implement a ML function (e.g., an AI function) which may generate the outputs 325 based on the inputs 320.

In some examples, a ML feature name (MLFN) 330 may be used to identify a function performed by the ML model 305. For example, the MLFN 330 may correspond to CSI feedback, beam management, positioning, reordering procedures (e.g., awaiting for missing packets, reordering arrived packets, in accordance with a reordering timer), or other functionalities. In some cases, the ML model 305 may be identified using a model ID. For example, the MLFN 330 may be associated with a model ID corresponding to the ML model 305. Each model ID may correspond to (e.g., identify) a ML model 305 (e.g., a ML model 305-a and a ML model 305-b) having a defined model structure 310, one or more parameter sets 315, or a combination thereof, as described herein. Additionally, or alternatively, the MLFN 330 may identify the ML model 305 using a model structure ID (e.g., MS ID), parameter set ID (e.g., PS IDs), or both. For example, the MLFN 330 may be associated with one or more model structure IDs, and each structure ID may identify a model structure 310 of a ML model 305. The MLFN 330 (e.g., or each structure ID) may also be associated with one or more parameter set IDs, each parameter set ID identifying a corresponding parameter set 315 for use with the corresponding model structure 310.

As such, model information may include MLFNs 330, model IDs, a model structure IDs, parameter set IDs, or a combination thereof. In some examples, each model ID may be associated with a model structure 310 and one or more parameter sets 315, and may be represented by a string. For instance, the string may correspond to a flat namespace, such as a single value that represents a tuple that includes the model structure 310 and the one or more parameter sets 315. Alternatively, the string may be a hierarchical namespace, such as the tuple including the model structure 310 and the one or more parameter sets 315.

In some cases, each model ID may be unique with respect to an MLFN 330. For example, each model ID may identify a separate ML model 305 (e.g., for a vendor), and may be unique such that each model ID refers to a single corresponding ML model 305. Similarly, each model structure ID may also be unique with respect to a MLFN 330. In some cases, each model ID, model structure ID, or both, may be specific to a public land mobile network (PLMN). Additionally, or alternatively, the model IDs and model structure IDs may be standardized or may administered separately (e.g., per vendor) without standardizing.

A network entity 105 or a base station 140 may configure and manage use of the ML model 305 for a UE 115. In some examples, the network entity 105 or the base station 140 may manage ML at the UE 115 at a feature level, for example, by configuring the UE 115 by indicating a MLFN 330. Additionally, or alternatively, the network entity 105 or the base station 140 may manage ML models 305 within each feature, and may configure the UE 115 using specific model IDs (e.g., indicating a model structure 310 and one or more parameter sets 315) corresponding to each feature. In some examples, the network entity 105 or the base station 140 may manage the parameter sets of each ML model 305, and the network entity 105 or the base station 140 may configure the UE 115 by indicating a model structure ID corresponding to a model structure 310 and one or more parameter sets 315. The parameter sets 315 may be explicitly indicated by the network entity 105 or the base station 140 to the UE 115, which may allow for more flexibility of the parameters, and may reduce the storage requirements at the UE 115 for storing parameter sets 315. Alternatively, the network entity 105 or the base station 140 may indicate the parameter sets 315 using one or more parameter IDs, which may reduce communication overhead between the UE 115 and the network entity 105 or the base station 140.

In some examples, ML models 305 may be one-sided models, which may be performed entirely at a UE 115 or the network (e.g., at one or more network entities 105 or base stations 140), or two-sided models, which may be performed at both the UE 115 and the network (e.g., the network entity 105 and/or the base station 140). One-sided models may be UE-side ML models 305, in which inference (e.g., running of the ML models 305) is performed at the UE 115. For example, the UE-side ML models 305 may involve non-UE specific inputs 320 (e.g., common to multiple UEs 115) and UE-specific inputs 320 (e.g., control inputs 320). In some cases, the UE 115 may receive control signaling or additional inputs 320 for the ML models 305 from a network entity 105 or a base station 140, while the ML model 305 inference is performed entirely at the UE 115. Inference for network-side ML models 305 may be performed at the network (e.g., at one or more network entities 105 or base stations 140), and the network may receive inputs 320 from the UE 115 to enter into the ML models 305. In some examples, the network may indicate the outputs 325 to the UE 115.

In two-sided ML models 305, joint inference may be performed. For example, one part of inference may be performed by the UE 115, and a remaining portion of the inference may be performed by one or more network entities 105 or base stations 140. For example, the UE 115 may perform a first portion of the inference for a ML model 305, and the network may perform a second part of the inference (e.g., based on data received from the UE 115, for example). Alternatively, the network may perform the first portion of the inference for a ML model 305, and the UE 115 may perform the second part of the inference (e.g., based on data received from the network entity 105 or the base station 140). To perform inference for the two-sided ML model 305, a network entity 105 or a base station 140 may signal one or more inputs 320 or other control signaling to the UE 115. Additionally, or alternatively, the UE 115 may transmit signaling indicating one or more inputs 320 or other control signaling to the network.

Accordingly, ML models 305 may be performed at a UE 115 or at one or more network entities 105 or base stations 140, as managed by the network, to perform different functions that may improve the operations and efficiency of the UE 115 and the network as described herein.

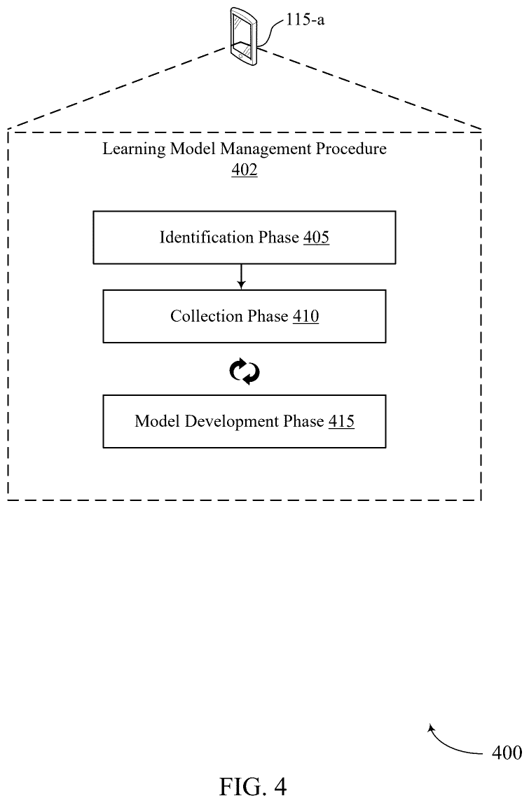

FIG. 4 shows an example of a block diagram 400 of a UE 115-a that supports AI-enabled reordering in accordance with one or more aspects of the present disclosure. The UE 115-a may be an example of aspects of a UE 115 as described herein with reference to FIGS. 1 and 2, respectively. The UE 115-a may implement aspects of the wireless communications system 100 as described with reference to FIG. 1.

In the example of FIG. 4, the UE 115-a may support a learning model management procedure 402 associated with one or more ML models for reordering of SDUs/PDUs, as described herein. The learning model management procedure 402 may include one or more of an identification phase 405, a collection phase 410 (also referred to as a data collection phase), and a model development phase 415.

One or more operations of the learning model management procedure 402 may be implemented by the UE 115-a or components (e.g., one or more memories storing processor-executable code, one or more processors coupled with the one or more memories and individually or collectively operable to execute the code to cause the UE 115-a to perform the operations) as described herein. In the following description of the learning model management procedure 402, the one or more operations performed by the UE 115-a may be performed in different orders or at different times. Some operations may also be omitted from the learning model management procedure 402, and other operations may be added to the learning model management procedure 402.

During the identification phase 405, the UE 115-a may identify an opportunity of applying a learning model. For example, the UE 115-a may identify a ML feature (MLF) for development at the UE 115-a. The UE 115-a may determine a use case for the learning model. In some examples, the UE 115-a may determine a task (e.g., an action) associated with the learning model, may determine inputs and outputs of the learning model, or both.

During the collection phase 410, the UE 115-a may collect data. For example, the UE 115-a may collect data based on actions or measurements that the UE 115-a performs, or the UE 115-a may collect data from multiple network elements (e.g., UEs, network entities, base stations). The data collected may be used as an input to the learning model for model development.

During the model development phase 415, the UE 115-a may process the data (e.g., before inputting the data to the learning model, as part of inputting the data to the learning model). To process the data, the UE 115-a may utilize one or more data filters, one or more selection criteria, or other data preparation parameters or procedures. The UE 115-a may design the model. A design of the learning model may be based on the MLF, the data available to the UE 115-a, one or more target outputs of the learning model, or a combination thereof. The UE 115-a may train the learning model (e.g., using the input data), and the UE 115-a may perform validation and testing of the learning model. For example, the UE 115-a may determine an accuracy or a reliability of the learning model and may calculate one or more accuracy metrics of the learning model. In some examples, the UE 115-a may continue to collect data for the learning model until the learning model has reached a threshold accuracy or reliability.

In some examples, multiple models may be developed for a same MLF (e.g., a same use case). The different models may be applicable to difference deployment environments, scenarios, or regions (e.g., geographical regions). In some examples, learning models may be universal models and may be generalized models that are applicable across deployments (e.g., all deployments). Universal models may be device specific or hardware specific. Some learning models may be regional models which may be deployment specific or network specific. Regional models may be applicable to some deployments, networks, and/or regions, but not others. Some learning models may be local models which may be applicable to a specific cell or to a local geographical area.

The UE 115-a may be capable of out-of-band or on-demand download of learning models. For example, because some models may be regional models or local models, the UE 115-a may download such learning models once the UE 115-a is in the field (e.g., on-demand downloading). In some examples, on-demand downloading of learning models at the UE 115-a may enable the UE 115-a to perform firmware over-the-air (FOTA) updates of existing models (e.g., downloaded models, such as out-of-band downloaded models), which may support federated learning of learning models.

Additionally, or alternatively, the learning model management procedure 402 may include a deployment of one or more learning models. For example, the UE 115-a may perform delivery or reception of a learning model (e.g., via an over the air interface or other signaling). That is, the UE 115-a may transmit an indication of the learning model to a network entity 105 or a base station 140 or may receive an indication of the learning model from a network entity 105 or a base station 140. In some examples, the indication of the learning model may indicate a partial model or a full model. A structure of the learning model may be known at a device receiving the learning model and the indication may include parameters for the model, or the indication may include a model (e.g., a model structure unknow by the UE 115-a) and parameters for the model.

The indication of the learning model may include a model executable. The model executable may be adjusted for different hardware platforms based on capabilities of the hardware platform and/or performance tradeoffs. The model executable may be downloaded directly to the UE 115-a or may be retrieved by the UE 115-a from a model repository (e.g., a database). In some cases, due to a memory restriction at the UE 115-a, the learning model may be downloaded by the UE 115-a during runtime. Additionally, or alternatively, the indication of the learning model may include one or more model management protocols. The model management protocols may include network and/or UE protocol functions to run the model. Additionally, or alternatively, the model management protocols may include layer 1 (L1)/layer 2 (L2) or RRC function handling (e.g., CSI type III support, MAC-control elements (MAC-CEs), RRC signaling for channel state feedback (CSF) configuration. In some cases, the model management protocols may include updated UE capabilities handling information (e.g., UE radio capability for CSF and supported CSF models).

The UE 115-a may retrieve the learning model from one or more model repositories. The model repository may store the model to download (e.g., transfer) to the UE 115-a. In some examples, the model repository may be a server (e.g., mobile network operator (MNO)). A model and parameter set configuration (e.g., indicating a set of learning models to be downloaded to the UE 115-a) may be configurable (e.g., dynamic), or may be static. Downloading the learning model to the UE 115-a may be in accordance with a model download format. The model download format may be a binary executable file or image or may be a model descriptor or label (e.g., in accordance with an open neural network exchange (ONNX)). In some examples, model quantization and/or compilation may be during an out-of-band period or may be during a runtime period of the UE 115-a.

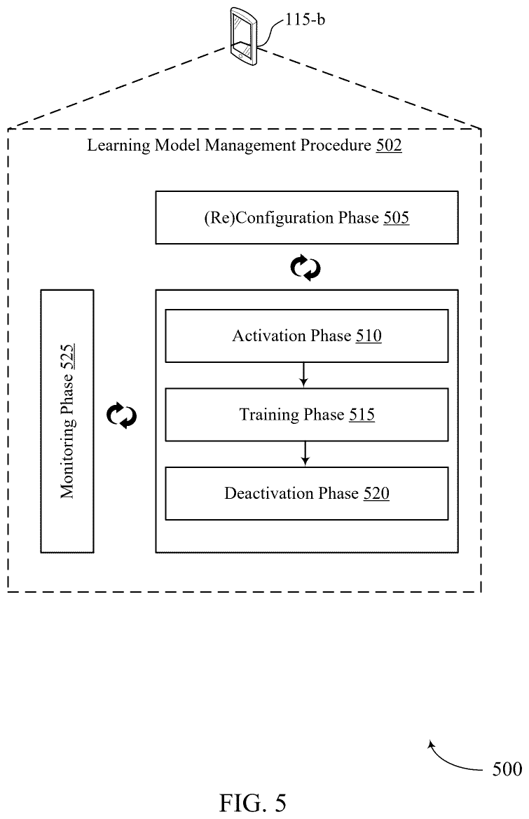

A learning model may undergo a life cycle, where the learning model progresses from one step of the life cycle to another. Steps of the model life cycle may include model development, model deployment, and model execution. For example, after development of a learning model, the learning model may be deployed. Based on model deployment, the UE 115-a may collect feedback of the learning model and may perform additional model development of the learning model (e.g., to improve or iterate on the learning model) based on the feedback. After model deployment, the learning model may be configured (e.g., for a particular use case, scenario), and the learning model may be executed by the UE 115-a (e.g., as described in greater detail with reference to FIG. 5). Based on model execution, the UE 115-a may collect feedback, may collect additional data, or both. The UE 115-a may perform model development of the learning model to improve the learning model based on the feedback and the additional data collected.

FIG. 5 shows a block diagram 500 of a UE 115-b that supports AI-enabled reordering in accordance with one or more aspects of the present disclosure. The UE 115-b may be an example of aspects of a UE 115 as described herein with reference to FIGS. 1 and 2, respectively. The UE 115-b may implement aspects of the wireless communications system 100 as described with reference to FIG. 1.

In the example of FIG. 5, the UE 115-b may support a learning model management procedure 502 associated with one or more ML models for reordering of SDUs/PDUs. The learning model management procedure 502 may include one or more of a (re) configuration phase 505, an activation phase 510, a training phase 515 (also referred to as an inference phase), a deactivation phase 520, or a monitoring phase 525. The one or more learning models may be locally stored (e.g., one or more memories storing processor-executable code) at the UE 115-b. Alternatively, the UE 115-b may obtain (e.g., download) the one or more learning models, for example, via a network entity 105 or a base station 140, as described herein with reference to FIGS. 1 and 2.

One or more operations of the learning model management procedure 502 may be implemented by the UE 115-b or components (e.g., one or more memories storing processor-executable code, one or more processors coupled with the one or more memories and individually or collectively operable to execute the code to cause the UE 115-b to perform the operations) as described herein. In the following description of the learning model management procedure 502, the one or more operations performed by the UE 115-b may be performed in different orders or at different times. Some operations may also be omitted from the learning model management procedure 502, and other operations may be added to the learning model management procedure 502.

During the (re) configuration phase 505, the UE 115-b may receive, from a network entity 105 or a base station 140, a set of one or more configurations including a set of one or more parameters for configuring or reconfiguring one or more learning models (e.g., AI models, ML models). The UE 115-b may receive, from a network entity 105 or a base station 140, a request message for configuring or reconfiguring the one or more learning models. The request may include the set of one or more configurations and one or more identifiers associated with one or more learning models. The UE 115-b may transmit, to the network entity 105 or the base station 140, a response message that includes an acknowledgement of the request message.

In some examples, the set of one or more parameters may be for managing (e.g., training, updating, modifying) the one or more learning models. In some other examples, the set of one or more parameters may be an input for the one or more learning models, for example, for inference of the one or more learning models. In other examples, the set of one or more parameters may be for monitoring one or more performance metrics (also referred to as key performance indicators (KPIs)) for the one or more learning models. Additionally, or alternatively, the set of one or more configurations may include one or more RRC configurations (e.g., one or more measurement configurations, one or more MAC configurations, or the like).

During the activation phase 510, the UE 115-b may activate at least one learning model (e.g., for at least one action). During the training phase 515, the UE 115-b may train the at least one learning model to obtain a set of one or more outputs based at least in part on a set of one or more inputs (e.g., a set of one or more parameters). During the deactivation phase 520, the UE 115-b may deactivate the at least one learning model (e.g., for at least one action).

During the monitoring phase 525, the UE 115-b may monitor (e.g., track) a performance of the at least one learning model. One or more of a network entity 105, a base station 140, or the UE 115-b may share (e.g., transmit, receive, exchange) feedback associated with the performance of the at least one learning model. The performance may be associated with a system performance (e.g., spectral efficiency, power consumption, delay, etc.) or a model performance (e.g., prediction accuracy, resource usage, inference delay, etc.). In some examples, one or more of a network entity 105, a base station 140, or the UE 115-b may trigger a switching event that includes switching (e.g., changing) from at least one learning model to at least one different learning model, for example, based at least in part on feedback associated with a performance of the at least one learning model. In some other examples, one or more of a network entity 105, a base station 140, or the UE 115-b may update the training of the at least one learning model based at least in part on the feedback associated with the performance of the at least one learning model.

The UE 115-b may switch from at least one learning model to at least one different learning model based at least in part on a function supported by the different learning model. In some examples, the UE 115-b may receive, from a network entity 105 or a base station 140, a request message to switch to the at least one different learning model. The request message may indicate an identifier associated with the at least one different learning model, and the UE 115-b may identify the least one different learning model based at least in part on the identifier. During the activation phase 510 of the learning model management procedure 502, the UE 115-b may activate the at least one different learning model (e.g., a different AI/ML model). Additionally, during the deactivation phase 520, the UE 115-b may deactivate the at least one learning model (e.g., a current AI/ML model).

Additionally, or alternatively, during the monitoring phase 525, the UE 115-b may trigger the switching event based at least in part on a change in one or more parameters of the UE 115-b (e.g., a number of antennas, a number of carriers, etc.). In some examples, the UE 115-b may trigger the switching event based at least in part on a change in a location of the UE 115-b (e.g., a change from an indoor environment to an outdoor environment, or vice-versa). In some other examples, the UE 115-b may trigger the switching event based at least in part on a change in a service (e.g., network slice, QoS flow, session, etc.).

Accordingly, the UE 115-b may be configured to support managing (e.g., configuring, reconfiguring, activating, deactivating, monitoring, reporting, etc.) of one or more leaning models.

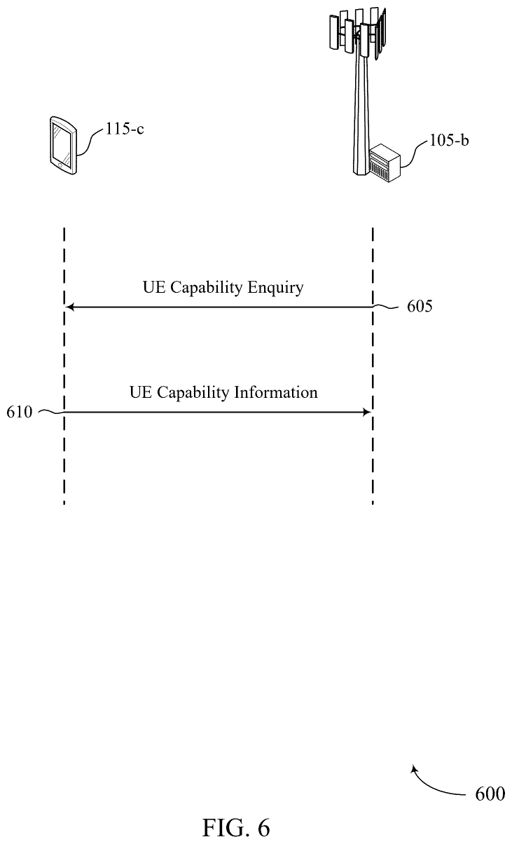

FIG. 6 shows an example of a process flow 600 that supports AI-enabled reordering in accordance with one or more aspects of the present disclosure. The process flow 600 may implement aspects of the wireless communications system 100 as described with reference to FIG. 1. The process flow 600 may include a UE 115-c and a network entity 105-b, which may be examples of UEs 115 and network entities 105 as described herein. In the following description of the process flow 600, the operations between the UE 115-c and the network entity 105-b may be transmitted in a different order than the example order shown, or the operations performed by the UE 115-c and the network entity 105-b may be performed in different orders or at different times. Some operations may also be omitted from the process flow 600, and other operations may be added to the process flow 600.

In the example of FIG. 6, the UE 115-c may support providing an indication to the network entity 105-b of one or more learning models, including one or more features for reordering of SDUs/PDUs, supported by the UE 115-c. At 605, the network entity 105-b may transmit, and the UE 115-c may receive, a request message (e.g., a UE capability enquiry). The UE 115-c may determine, in response to the UE capability enquiry, a set of one or more UE capabilities. For example, the UE 115-c may determine whether the UE 115-c supports AI/ML functionality, including one or more learning models (e.g., AI/ML models) or one or more features associated with the one or more learning models for AI-enabled reordering of SDUs/PDUs.

At 610, the UE 115-c may transmit, and the network entity 105-b may receive, a response messages (e.g., UE capability information), in response to the request message. The UE capability information may include a set of one or more features supported by the UE 115-c. In some examples, the UE capability information may include a set of one or more identifiers associated with the one or more learning models, supported by the UE 115-c. Additionally, or alternatively, the UE capability information may include at least one field (e.g., information element (IE), flag, or the like) that indicates whether a corresponding learning model is loaded (e.g., initialized, stored, cached, or the like) at the UE 115-c. Additionally, or alternatively, the UE capability information may include a set of one or more identifiers associated with one or more learning model structures, or a set of one or more parameters for one or more features associated with the one or more learning model structures.

Accordingly, the UE 115-c may be configured to support exchange of UE capability information associated with one or more learning models for AI-enabled reordering.

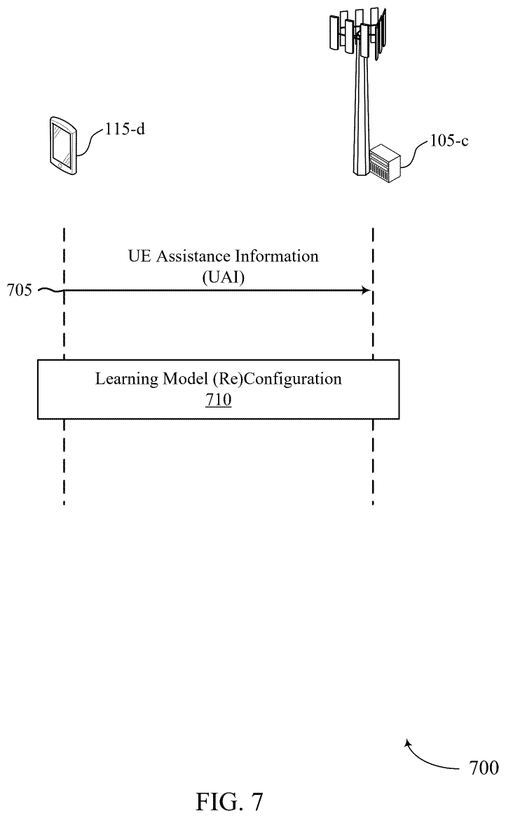

FIG. 7 shows an example of a process flow 700 that supports AI-enabled reordering in accordance with one or more aspects of the present disclosure. The process flow 700 may implement aspects of the wireless communications system 100 as described with reference to FIG. 1. The process flow 700 may include a UE 115-d and a network entity 105-c, which may be examples of UEs 115 and network entities 105 as described herein. In the following description of the process flow 700, the operations between the UE 115-d and the network entity 105-c may be transmitted in a different order than the example order shown, or the operations performed by the UE 115-d and the network entity 105-c may be performed in different orders or at different times. Some operations may also be omitted from the process flow 700, and other operations may be added to the process flow 700.

In the example of FIG. 7, the UE 115-d may support providing UE assistance information (UAI) to the network entity 105-c. More specifically, the UE 115-d may support transmitting, to the network entity 105-c, UAI for managing one or more learning models for AI-enabled reordering of SDUs/PDUs. At 705, the UE 115-d may transmit, and the network entity 105-c may receive, UAI that may indicate one or more restrictions (also referred to as restricted UE capabilities) associated with the one or more learning models for AI-enabled reordering of SDUs/PDUs. For example, the restricted UE capabilities may include a set of one or more learning models, a set of one or more identifiers associated with the set of one or more learning models, or both. In some examples, the restricted UE capabilities may exclude the set of one or more identifiers. In some examples, the UE 115-d may indicate a request to adjust (e.g., reduce, decrease, increase) a concurrency of the one or more learning models. For example, the UE 115-d may indicate a threshold number of concurrency (e.g., “maxAImachine learningconcurrency-Preference”) associated with the one or more learning models.

The UE 115-d may generate and transmit the UAI to the network entity 105-c based at least in part on a condition (e.g., an event). One or more examples of a condition may include, but is not limited to, a battery level of the UE 115-d satisfying a battery level threshold, a processor usage level of one or more processors of the UE 115-d satisfying a processor usage level threshold, or a heat level of one or more processors of the UE 115-d satisfying a heat level threshold. For example, the UE 115-d may transmit the UAI to the network entity 105-c to manage (e.g., deactivate, activate) one or more learning models for AI-enabled reordering of SDUs/PDUs at the UE 115-d based at least in part on one or more of the battery level of the UE 115-d satisfying the battery level threshold, the processor usage level of the one or more processors of the UE 115-d satisfying the processor usage level threshold, or the heat level of the one or more processors of the UE 115-d satisfying the heat level threshold.

Additionally, or alternatively, in some examples, the UAI may include a request for a set of one or more configurations associated with one or more learning models for AI-enabled reordering of SDUs/PDUs. In some examples, the UE 115-d may request the network entity 105-c for the set of one or more configurations associated with the one or more learning models based at least in part on a change in an environment of the UE 115-d. In some other examples, the UE 115-d may request the network entity 105-c for the set of one or more configurations associated with the one or more learning models based at least in part on a change in a state of the UE 115-d (e.g., a change between one or more of an idle state, an inactive state, or a connected state).

In other examples, the UE 115-d may request the network entity 105-c for the set of one or more configurations associated with the one or more learning models for AI-enabled reordering of SDUs/PDUs based at least in part on a session establishment associated with a network slice. For example, the UE 115-d may establish a session (e.g., a PDU session) associated with the network slice, and request the network entity 105-c for the set of one or more configurations associated with the one or more learning models for AI-enabled reordering of SDUs/PDUs. In some other examples, the UE 115-d may request the network entity 105-c for the set of one or more configurations associated with the one or more learning models for AI-enabled reordering of SDUs/PDUs based at least in part on a change in a geographic coverage area of the UE 115-d. For example, the UE 115-d may enter a new geographic coverage area of a cell, PLMN, and request the network entity 105-c for the set of one or more configurations associated with the one or more learning models for AI-enabled reordering of SDUs/PDUs.

At least one configuration of the set of one or more configurations associated with provisioning of network data as input for one or more learning models (e.g., AI/ML models). In some examples, the at least one configuration may indicate at least one identifier associated with at least one learning model supporting the network data as input to the least one learning model. In some examples, the UE 115-d may request (e.g., on-demand) for the network data from the network entity 105-c via the UAI, for example, based at least in part on the set of one or more configurations associated with provisioning of network data as input for one or more learning models (e.g., AI/ML models).

At 710, one or more of the UE 115-d or the network entity 105-c may configure or reconfigure at least one learning model for AI-enabled reordering of SDUs/PDUs. For example, the network entity 105-c may select at least one learning model to deactivate at the UE 115-d, based at least in part on the UAI, and transmit control signaling (e.g., RRC, MAC-CE, DCI) for deactivating the at least one learning model. For example, the network entity 105-c may determine and select which learning model to deactivate at the UE 115-d based at least in part on the UAI, and transmit the control signaling (e.g., RRC, MAC-CE, DCI) that indicates for the UE 115-d to deactivate the at least one learning model for AI-enabled reordering of SDUs/PDUs. Additionally, or alternatively, the network entity 105-c may determine and select which learning model to configure or reconfigure and activate at the UE 115-d based at least in part on the UAI. For example, the network entity 105-c may determine and select which learning model to activate at the UE 115-d based at least in part on the UAI, and transmit control signaling (e.g., RRC, MAC-CE, DCI) that indicates for the UE 115-d to activate the at least one learning model for AI-enabled reordering of SDUs/PDUs.

Accordingly, the UE 115-d may be configured to support exchange of UAI for managing learning models that support selecting a duration for a reordering timer for the UE 115-d. For instance, the activated learning model may be used to predict a duration for arrival of one or more missing packets (e.g., SDUs), which may be used to adjust a duration for a reordering timer of the UE 115-d.

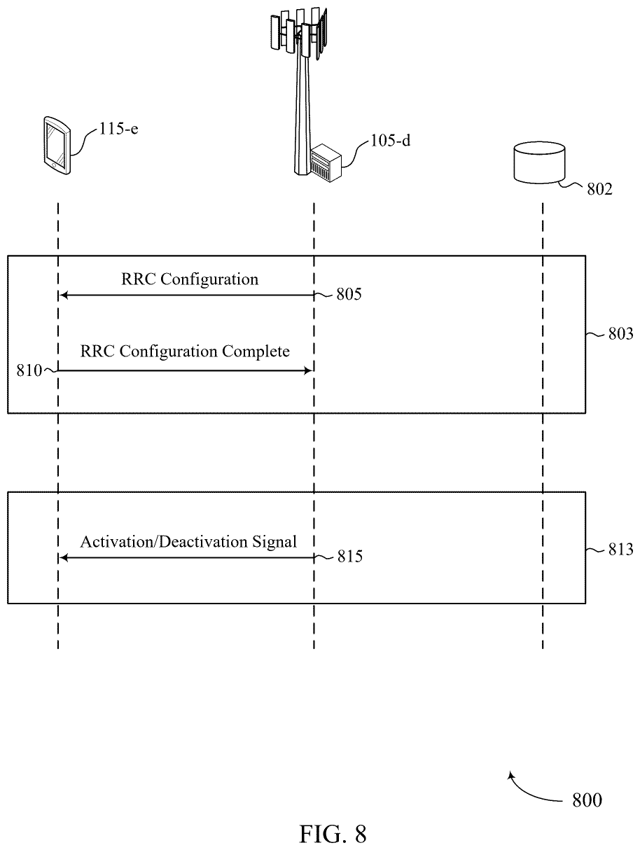

FIG. 8 shows an example of a process flow 800 that supports AI-enabled reordering in accordance with one or more aspects of the present disclosure. The process flow 800 may implement aspects of the wireless communications system 100 as described with reference to FIG. 1. The process flow 800 may include a UE 115-e and a network entity 105-d, which may be examples of UEs 115 and network entities 105 as described herein. Additionally, the process flow 800 may include a repository 802 (e.g., a database) storing one or more learning models for AI-enabled reordering of SDUs/PDUs. In the following description of the process flow 800, the operations between the UE 115-e, the network entity 105-d, and the repository 802 may be transmitted in a different order than the example order shown, or the operations performed by the UE 115-e, the network entity 105-d, and the repository 802 may be performed in different orders or at different times. Some operations may also be omitted from the process flow 800, and other operations may be added to the process flow 800.

In the example of FIG. 8, one or more of the UE 115-e or the network entity 105-d may support performing a procedure 803 (e.g., a model configuration procedure), which may include an exchange of a set of one or more configurations (or a set of one or more parameters) associated with one or more learning models for AI-enabled reordering of SDUs/PDUs. The set of one or more configurations (or the set of one or more parameters) associated with the one or more learning models for AI-enabled reordering of SDUs/PDUs may be stored at the repository 802 (e.g., a database, or the like), which the network entity 105-d may obtain from the repository 802.

At 805, the network entity 105-d may transmit, and the UE 115-e may receive, an RRC configuration message, which may include one or more sets of one or more configurations (or one or more sets of one or more parameters) associated with one or more learning models for AI-enabled reordering of SDUs/PDUs. The network entity 105-d may transmit, and the UE 115-e may receive, the RRC configuration message during the procedure 803, which may be an RRC configuration procedure. In some examples, the UE 115-e may configure one or more learning models via a layer 3 (L3) of the UE 115-e and based at least in part on the one or more sets of one or more configurations (or the one or more sets of one or more parameters) received in the RRC configuration message. At 810, the UE 115-e may transmit, and the network entity 105-d may receive, an RRC configuration complete message, for example, based at least in part on the RRC configuration message. The RRC configuration complete message may indicate a completion of the procedure 803 (e.g., the RRC configuration procedure), including configuring of the one or more learning models for AI-enabled reordering of SDUs/PDUs.

In the example of FIG. 8, additionally, or alternatively, at least one configuration of the sets of one or more configurations may be for provisioning network data by the network entity 105-d to the UE 115-e for input to one or more learning models (e.g., AI/ML models). In some examples, the at least one configuration may indicate at least one identifier associated with at least one learning model supporting the network data as input to the least one learning model. In some examples, the UE 115-e may request the network entity 105-d to activate or deactivate provisioning of network data as input to the at least one learning model via a MAC-CE. In some examples, the UE 115-e may receive, and the network entity 105-d may transmit, the network data via a unicast transmission and over a physical downlink channel (e.g., a physical downlink control channel (PDCCH), a physical downlink shared channel (PDSCH)). In some other examples, the UE 115-e may receive, and the network entity 105-d may transmit, the network data via a MAC-CE or an RRC message. In other examples, the UE 115-e may receive, and the network entity 105-d may transmit (e.g., broadcast), the network data via system information or a multicast broadcast service (MBS) transmission.

Additionally, or alternatively, at least one configuration of the sets of one or more configurations may be for provisioning, to the network entity 105-d, UE data as input for one or more learning models (e.g., AI/ML models). In some examples, the at least one configuration may indicate at least one identifier associated with at least one learning model supporting the UE data as input to the least one learning model. The network entity 105-d may request, from the UE 115-e, to activate or deactivate provisioning of UE data as input to the at least one learning model via a MAC-CE. In some examples, the UE 115-e may transmit, and the network entity 105-d may receive, UE data via a unicast transmission and over a physical uplink channel (e.g., a physical uplink control channel (PUCCH), a physical uplink shared channel (PUSCH)). In some other examples, the UE 115-e may transmit, and the network entity 105-d may receive, the UE data via a MAC-CE or an RRC message.

At 815, the network entity 105-d may transmit, and the UE 115-e may receive, a signal (also referred to as an activation signal or a deactivation signal) for activating or deactivating one or more learning models for AI-enabled reordering of

SDUs/PDUs during a procedure 813 (e.g., an activation/deactivation procedure of one or more learning models for AI-enabled reordering of SDUs/PDUs). In some examples, the network entity 105-d may transmit, and the UE 115-e may receive via a layer 2 (L2) of the UE 115-e, the signal for activating or deactivating the one or more learning models for AI-enabled reordering of SDUs/PDUs. For example, the network entity 105-d may transmit, and the UE 115-e may receive, a MAC-CE that activates or deactivates the one or more learning models for AI-enabled reordering of SDUs/PDUs. In some examples, activating or deactivating the one or more learning models for AI-enabled reordering of SDUs/PDUs may be based at least in part on a switching event as described herein with reference to FIGS. 3 through 5

Accordingly, one or more of the UE 115-e or the network entity 105-d may be configured to support managing learning models based at least in part on activating or deactivating one or more learning models, which allows flexible management of reordering timer durations using learning models.

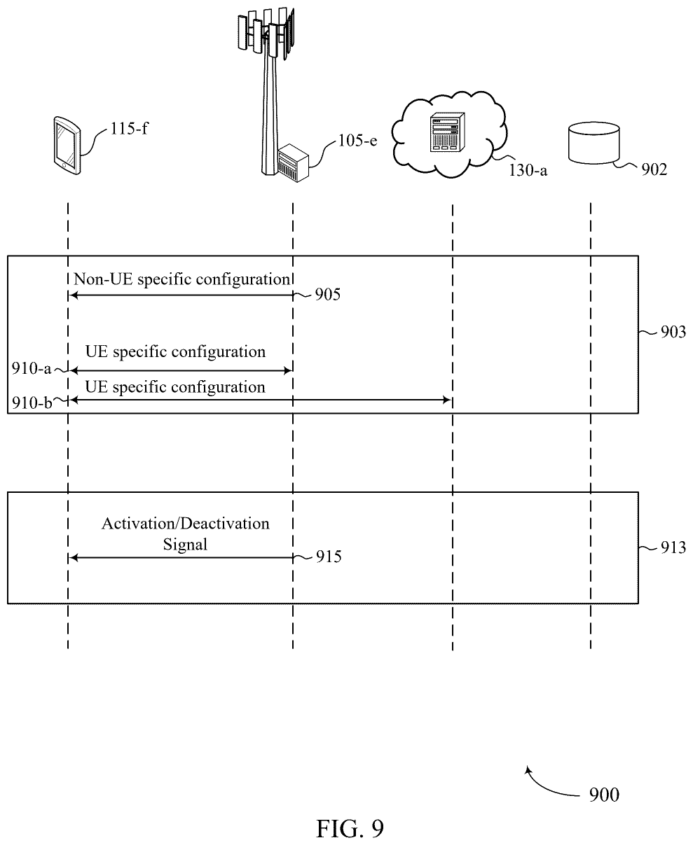

FIG. 9 shows an example of a process flow 900 that supports AI-enabled reordering in accordance with one or more aspects of the present disclosure. The process flow 900 may implement aspects of the wireless communications system 100 as described with reference to FIG. 1. The process flow 900 may include a UE 115-f, a network entity 105-e, and a core network 130-a, which may be examples of UEs 115, network entities 105, and core networks 130 as described herein. Additionally, the process flow 900 may include a repository 902 (e.g., a database) storing one or more learning models for AI-enabled reordering of SDUs/PDUs. In the following description of the process flow 900, the operations between the UE 115-f, the network entity 105-e, the core network 130-a, and the repository 902 may be transmitted in a different order than the example order shown, or the operations performed by the UE 115-f, the network entity 105-e, the core network 130-a, and the repository 902 may be performed in different orders or at different times. Some operations may also be omitted from the process flow 900, and other operations may be added to the process flow 900.

In the example of FIG. 9, one or more of the UE 115-f, the network entity 105-e, or the core network 130-a may support performing one or more procedures 903 or 913, which may include an exchange of a set of one or more configurations (or a set of one or more parameters) associated with one or more learning models for AI-enabled reordering of SDUs/PDUs. For example, one or more of the UE 115-f, the network entity 105-e, or the core network 130-a may support performing one or more procedures, which may exchange of the set of one or more configurations (or the set of one or more parameters) associated with the one or more learning models for AI-enabled reordering of SDUs/PDUs based at least in part on a state (e.g., an idle state, an inactivate state) of the UE 115-f. In some examples, one or more of the UE 115-f, the network entity 105-e, or the core network 130-a may support activating or deactivating the one or more learning models for AI-enabled reordering of SDUs/PDUs for inference during the state of the UE 115-f. For example, one or more of the UE 115-f, the network entity 105-e, or the core network 130-a may support activating or deactivating the one or more learning models for AI-enabled reordering of SDUs/PDUs to perform an inference (e.g., training) of the one or more learning models and cell selection, cell reselection, RLF recovery, measurement operations, random access channel operations (e.g., beam selection, random access channel occasions (RO), and the like).

At 905, the network entity 105-e may transmit, and the UE 115-f may receive, a set of one or more non-UE specific configurations. For example, the network entity 105-e may broadcast, and the UE 115-f may receive, system information including the set of one or more non-UE specific configurations. The system information may include a system information block (SIB). The set of one or more non-UE specific configurations may include one or more sets of one or more parameters, which may be associated with a set of one or more learning models for AI-enabled reordering of SDUs/PDUs and include a set of one or more identifiers associated with the set of one or more learning models for AI-enabled reordering of SDUs/PDUs, etc.

Additionally, or alternatively, at 910-a, the network entity 105-e may transmit, and the UE 115-f may receive, for example, via a unicast transmission, a set of one or more UE specific configurations for AI-enabled reordering of SDUs/PDUs. For example, the network entity 105-e may transmit, and the UE 115-f may receive, an RRC message including the set of one or more UE specific configurations. The set of one or more UE specific configurations may include one or more sets of one or more parameters, which may be associated with a set of one or more learning models including a set of one or more identifiers associated with the set of one or more learning models for AI-enabled reordering of SDUs/PDUs. In some examples, the RRC message may be an RRC release message during an RRC release procedure. In some examples, at 910-b, one or more of the UE 115-f, the network entity 105-e, or the core network 130-a (e.g., one or more network functions associated with the core network 130-a) may exchange one or more NAS messages associated with the set of one or more UE specific configurations.

At 915, the network entity 105-e may transmit, and the UE 115-f may receive, a signal (also referred to as an activation signal or a deactivation signal) for activating or deactivating one or more learning models for AI-enabled reordering of SDUs/PDUs. In some examples, the network entity 105-e may transmit, and the UE 115-f may receive, the signal for activating or deactivating the one or more learning models for AI-enabled reordering of SDUs/PDUs. For example, the network entity 105-e may transmit, and the UE 115-f may receive, a MAC-CE that activates or deactivates the one or more learning models for AI-enabled reordering of SDUs/PDUs and may perform an inference (e.g., training) of the one or more learning models during an idle state or an inactivate state of the UE 115-f. As such, activating or deactivating the one or more learning models for AI-enabled reordering of SDUs/PDUs may be based at least in part on the idle state or the inactivate state of the UE 115-f.

Accordingly, one or more of the UE 115-f, the network entity 105-e, or the core network 130-a may support activating or deactivating one or more learning models for AI-enabled reordering of SDUs/PDUs and for inference of the one or more learning models for AI-enabled reordering of SDUs/PDUs during an idle state or an inactivate state of the UE 115-f.

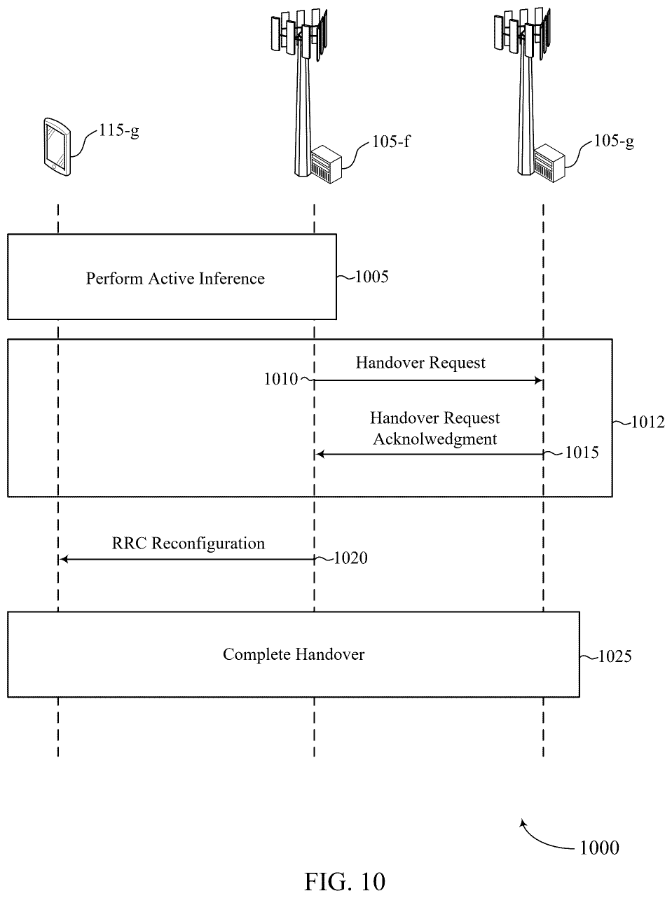

FIG. 10 shows an example of a process flow 1000 that supports AI-enabled reordering in accordance with one or more aspects of the present disclosure. The process flow 1000 may implement aspects of the wireless communications system 100 as described with reference to FIG. 1. The process flow 1000 may include a UE 115-g, a network entity 105-f, and a network entity 105-g, which may be examples of UEs 115 and network entities 105 as described herein. In the following description of the process flow 1000, the operations between the UE 115-g, the network entity 105-f, and the network entity 105-g may be transmitted in a different order than the example order shown, or the operations performed by the UE 115-g, the network entity 105-f, and the network entity 105-g may be performed in different orders or at different times. Some operations may also be omitted from the process flow 1000, and other operations may be added to the process flow 1000.

In the example of FIG. 10, one or more of the UE 115-g, the network entity 105-f, and the network entity 105-g may support managing AI-enabled reordering of SDUs/PDUs managing a reordering timer during a mobility (also referred to as UE mobility) of the UE 115-g. More specifically, one or more of the UE 115-g, the network entity 105-f, and the network entity 105-g may support managing AI/ML functionality for AI-enabled reordering of SDUs/PDUs managing a reordering timer associated with the UE 115-g during a handover procedure, which may include switching (e.g., transferring) a connection of the UE 115-g from the network entity 105-f (also referred to as a source base station) to the network entity 105-g (also referred to as a target base station) and while maintaining ongoing AI/ML functionality for AI-enabled reordering of SDUs/PDUs managing a reordering timer.

At 1005, one or more of the UE 115-g or the network entity 105-f may perform an active inference (e.g., training) of one or more learning models for AI-enabled reordering of SDUs/PDUs managing a reordering timer. The inference (e.g., training) of the one or more learning models for AI-enabled reordering of SDUs/PDUs managing a reordering timer may be based at least in part on one or more sets of one or more configurations, including one or more sets of one or more parameters, configured by the network entity 105-f.

At 1010, the network entity 105-f may transmit, and the network entity 105-g may receive, a handover request message, which may include context information (e.g., AI/ML context) associated with the one or more learning models for AI-enabled reordering of SDUs/PDUs managing a reordering timer, during a handover preparation 1012. At 1015, the network entity 105-g may transmit, and the network entity 105-f may receive, a handover request acknowledgment message during the handover preparation 1012, which may include one or more sets of one or more configurations for AI-enabled reordering of SDUs/PDUs managing a reordering timer, including one or more sets of one or more parameters, configured by the network entity 105-g. Put another way, the network entity 105-g may provide a set of one or more AI/ML configurations for the UE 115-g to apply after being handed over to the network entity 105-g by the network entity 105-f. In some examples, the network entity 105-f may determine the sets of one or more configurations for AI-enabled reordering of SDUs/PDUs managing a reordering timer, including the one or more sets of one or more parameters, based at least in part on the context information (e.g., AI/ML context) received from the network entity 105-g. Additionally, or alternatively, the network entity 105-f may determine the sets of one or more configurations, including the one or more sets of one or more parameters, based at least in part on one or more of UE capabilities of the UE 115-g or network capabilities of the network entity 105-g. In some examples, one or more of the UE 115-g or the network entity 105-g may support partial or full AI/ML functionality (e.g., enabling of one or more features associated with at least one learning model).

At 1020, the network entity 105-f may transmit, and the UE 115-g may receive, an RRC reconfiguration message, which include the sets of one or more configurations for AI-enabled reordering of SDUs/PDUs managing a reordering timer, including the one or more sets of one or more parameters, configured by the network entity 105-g. At 1025, one or more of the UE 115-g, the network entity 105-f, or the network entity 105-g may complete handover (e.g., a handover of the UE 115-g from the network entity 105-f to the network entity 105-g).

Accordingly, one or more of the UE 115-g, the network entity 105-f, or the network entity 105-g may support managing AI-enabled reordering of SDUs/PDUs managing a reordering timer during a mobility of the UE 115-g.

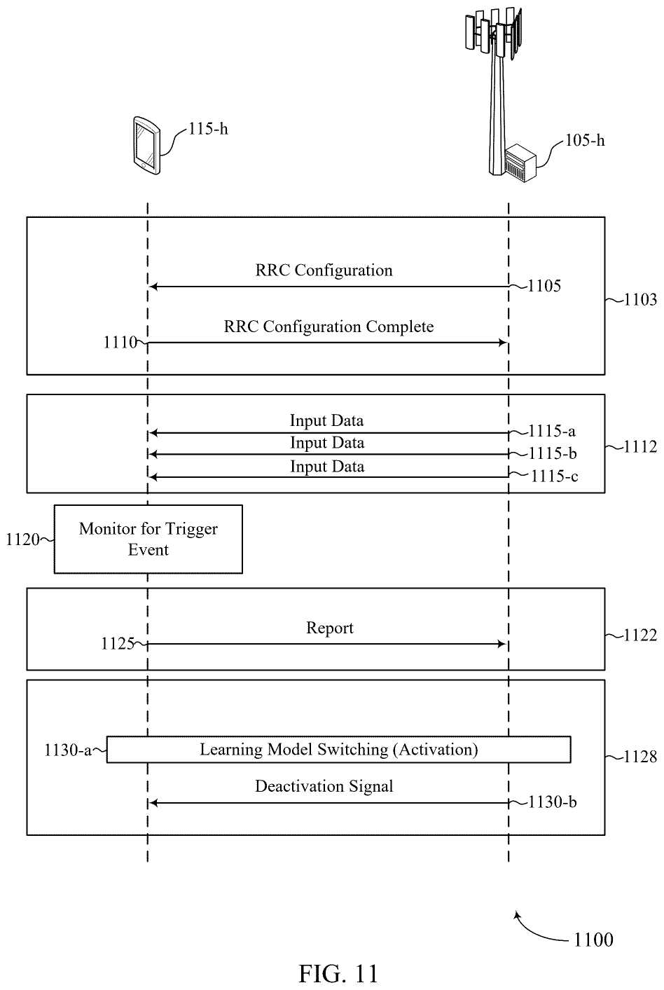

FIG. 11 shows an example of a process flow 1100 that supports AI-enabled reordering in accordance with one or more aspects of the present disclosure. The process flow 1100 may implement aspects of the wireless communications system 100 as described with reference to FIG. 1. The process flow 1100 may include a UE 115-h and a network entity 105-h, which may be examples of UEs 115 and network entities 105 as described herein. In the following description of the process flow 1100, the operations between the UE 115-h and the network entity 105-h may be transmitted in a different order than the example order shown, or the operations performed by the UE 115-h and the network entity 105-h may be performed in different orders or at different times. Some operations may also be omitted from the process flow 1100, and other operations may be added to the process flow 1100.

In the example of FIG. 11, one or more of the UE 115-h or the network entity 105-h may support activating and deactivating one or more learning models for AI-enabled reordering of SDUs/PDUs and management of a reordering timer based at least in part on reporting of feedback associated with the one or more learning models for AI-enabled reordering of SDUs/PDUs and management of a reordering timer by the UE 115-h.

At 1105, the network entity 105-h may transmit, and the UE 115-h may receive, an RRC message that includes a set of one or more RRC configurations during a procedure 1103 (e.g., an RRC procedure), which may include a set of one or more parameters. In some examples, one or more parameters of the set of one or more parameters may include one or more performance KPIs or one or more system KPIs, or a combination thereof. In some other examples, one or more parameters of the set of one or more parameters may include one or more monitoring events (e.g., thresholds, conditions). In other examples, one or more parameters of the set of one or more parameters may include one or more reporting events, reporting periodicity, etc. At 1110, the UE 115-h may transmit, and the network entity 105-h may receive, an RRC configuration complete message during the procedure 1103 (e.g., the RRC procedure).

At 1112, the network entity 105-h may transmit, and the UE 115-h may receive, input data, which may be input for one or more learning models for AI-enabled reordering of SDUs/PDUs and management of a reordering timer at the UE 115-h. In some examples, the network entity 105-h may transmit, and the UE 115-h may receive, input data via one or more unicast transmissions. For example, at 1115-a, 1115-b, and 1115-c, the network entity 105-h may transmit, and the UE 115-h may receive, input data via one or more unicast transmissions. In some other examples, the network entity 105-h may broadcast, and the UE 115-h may receive, input data via one or more broadcast transmissions as described herein with reference to FIGS. 3 through 8. For example, at 1115-a, 1115-b, and 1115-c, the network entity 105-h may transmit, and the UE 115-h may receive, input data via one or more broadcast transmissions.

At 1120, the UE 115-h may monitor for one or more events (e.g., threshold satisfied, conditions satisfied) associated with the one or more learning models for AI-enabled reordering of SDUs/PDUs and management of a reordering timer. At 1125, the UE 115-h may transmit, and the network entity 105-h may receive, a report based at least in part on the one or more events. For example, the UE 115-g may transmit, and the network entity 105-h may receive, the report during a reporting event 1122. The report may indicate the one or more performance KPIs or the one or more system KPIs, or a combination thereof.

At 1130-a, one or more of the UE 115-h or the network entity 105-h may switch between one or more learning models for AI-enabled reordering of SDUs/PDUs and management of a reordering timer during a switching or deactivation event 1128 as described herein. For example, one or more of the UE 115-h or the network entity 105-h may active at least one learning model of the one or more learning models for AI-enabled reordering of SDUs/PDUs and management of a reordering timer based at least in part on the reported one or more performance KPIs or the reported one or more system KPIs, or a combination thereof. Additionally, or alternatively, at 1130-b, one or more of the UE 115-h or the network entity 105-h may activate or deactivate at least one learning model of the one or more learning models for AI-enabled reordering of SDUs/PDUs and management of a reordering timer based at least in part on the reported one or more performance KPIs or the reported one or more system KPIs, or a combination thereof.

Accordingly, one or more of the UE 115-h or the network entity 105-h may support activating and deactivating one or more learning models for AI-enabled reordering of SDUs/PDUs and management of a reordering timer based at least in part on reported feedback associated with the one or more learning models for AI-enabled reordering of SDUs/PDUs and management of a reordering timer by the UE 115-h.

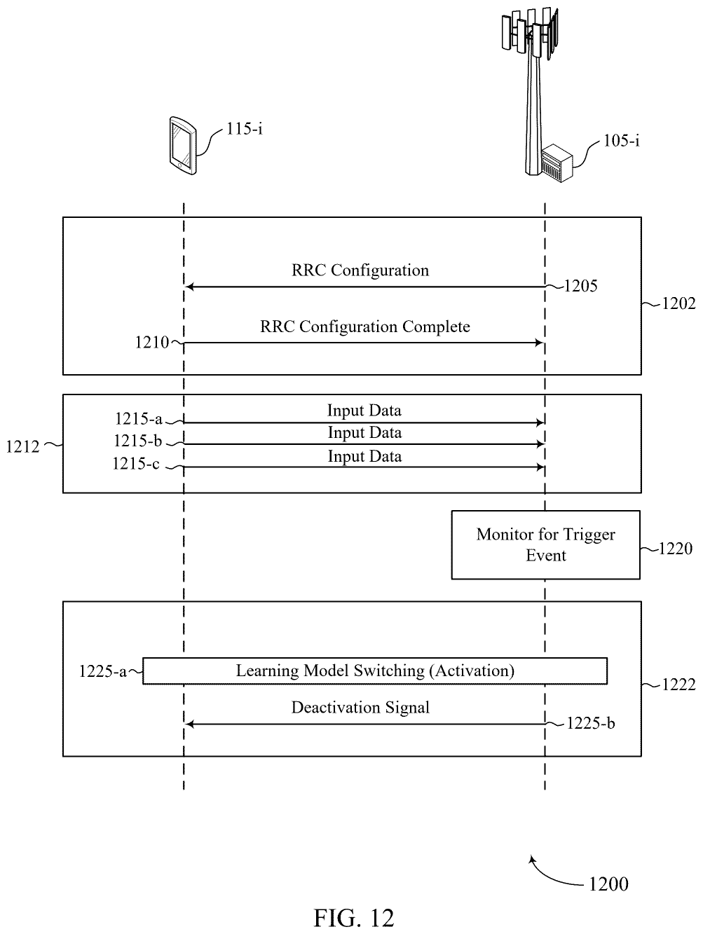

FIG. 12 shows an example of a process flow 1200 that supports AI-enabled reordering in accordance with one or more aspects of the present disclosure. The process flow 1200 may implement aspects of the wireless communications system 100 as described with reference to FIG. 1. The process flow 1200 may include a UE 115-i and a network entity 105-i, which may be examples of UEs 115 and network entities 105 as described herein. In the following description of the process flow 1200, the operations between the UE 115-i and the network entity 105-i may be transmitted in a different order than the example order shown, or the operations performed by the UE 115-i and the network entity 105-i may be performed in different orders or at different times. Some operations may also be omitted from the process flow 1200, and other operations may be added to the process flow 1200.

In the example of FIG. 12, one or more of the UE 115-i or the network entity 105-i may support activating and deactivating one or more learning models for AI-enabled reordering of SDUs/PDUs and management of a reordering timer based at least in part on monitoring by the network entity 105-i of the one or more learning models for AI-enabled reordering of SDUs/PDUs and management of a reordering timer.

At 1205, the network entity 105-i may transmit, and the UE 115-i may receive, an RRC message that includes set of one or more RRC configurations during a procedure 1202 (e.g., an RRC procedure), which may include a set of one or more parameters. In some examples, one or more parameters of the set of one or more parameters may include one or more performance KPIs or one or more system KPIs, or a combination thereof. At 1210, the UE 115-i may transmit, and the network entity 105-i may receive, an RRC configuration complete message during the procedure 1202 (e.g., the RRC procedure).

At 1212, the network entity 105-i may receive, and the UE 115-i may transmit, input data, which may be input for one or more learning models for AI-enabled reordering of SDUs/PDUs and management of a reordering timer at the network entity 105-i. In some examples, the network entity 105-i may receive, and the UE 115-i may transmit, input data via one or more unicast transmissions. For example, at 1215-a, 1215-b, and 1215-c, the network entity 105-i may receive, and the UE 115-i may transmit, input data via one or more unicast transmissions. At 1220, the network entity 105-i may monitor for one or more events (e.g., threshold satisfied, conditions satisfied) associated with the one or more learning models for AI-enabled reordering of SDUs/PDUs and management of a reordering timer at the network entity 105-i.

At 1225-a, one or more of the UE 115-i or the network entity 105-i may switch between one or more learning models for AI-enabled reordering of SDUs/PDUs and management of a reordering timer based at least in part on one or more events and during a switching or deactivation event 1222 as described herein. For example, one or more of the UE 115-i or the network entity 105-i may active at least one learning model of the one or more learning models for AI-enabled reordering of SDUs/PDUs and management of a reordering timer based at least in part on the one or more events as described herein. Additionally, or alternatively, at 1225-b, one or more of the UE 115-i or the network entity 105-i may deactivate at least one learning model of the one or more learning models for AI-enabled reordering of SDUs/PDUs and management of a reordering timer based at least in part on the one or more events as described herein. Accordingly, one or more of the UE 115-i or the network entity 105-i may support activating and deactivating one or more learning models for AI-enabled reordering of SDUs/PDUs and management of a reordering timer based at least in part on monitoring by the network entity 105-i of the one or more learning models for AI-enabled reordering of SDUs/PDUs and management of a reordering timer.

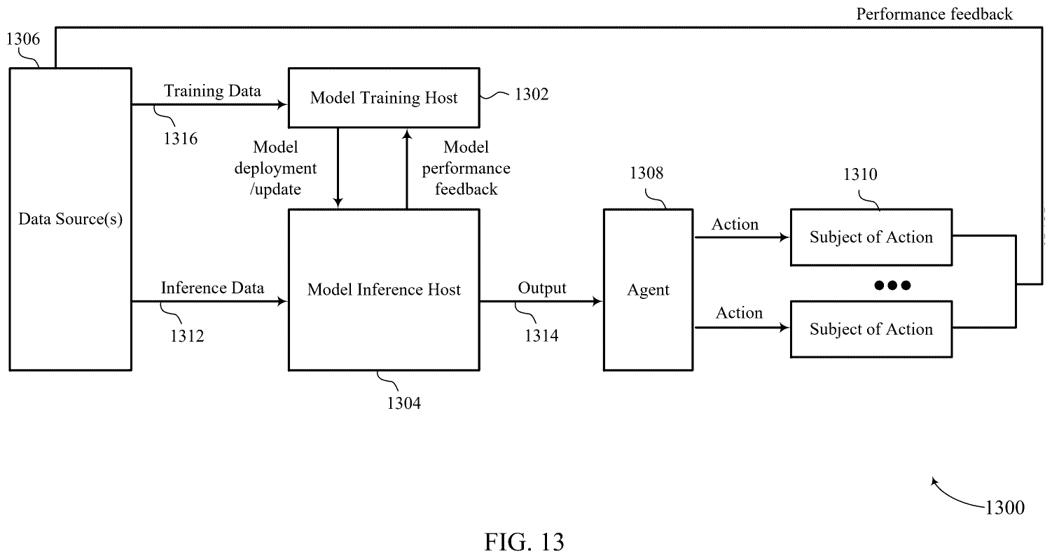

FIG. 13 is an illustrative block diagram of an example ML architecture that may be used for wireless communications in accordance with one or more aspects of the present disclosure. The ML architecture 1300 may be used for wireless communications in any of the various implementations, processes, environments, networks, or use cases listed above. As illustrated, architecture 1300 includes multiple logical entities, such as model training host 1302, model inference host 1304, data source(s) 1306, and agent 1308. Model inference host 1304 is configured to run an ML model based on inference data 1312 provided by data source(s) 1306. Model inference host 1304 may produce output 1314, which may include a prediction or inference, such as a discrete or continuous value based on inference data 1312, which may then be provided as input to the agent 1308.

Agent 1308 may represent an element or an entity of a wireless communication system including, for example, a radio access network (RAN), a wireless local area network, a device-to-device (D2D) communications system, etc. As an example, agent 1308 may be a UE (e.g., UE 115 as described with reference to FIGS. 1 through 12 and 14 through 19), a base station (e.g., a base station 140 as described with reference to FIG. 1), or a disaggregated network entity (such as a CU, a DU, or a RU as described with reference to FIG. 1), an access point, a wireless station, a RIC in a cloud-based RAN, among some examples. Additionally, agent 1308 also may be a type of agent that depends on the type of tasks performed by model inference host 1304, the type of inference data 1312 provided to model inference host 1304, or the type of output 1314 produced by model inference host 1304.

Agent 1308 may perform one or more actions associated with receiving output 1314 from model inference host 1304. For example, if agent 1308 is a UE 115 and the output from model inference host 1304 is associated with processing (e.g., reordering, forwarding) of PDUs and/or SDUs, the agent 1308 may adjust parameters dynamically for processing (e.g., reordering, forwarding) of PDUs and/or SDUs based on output 1314.

Agent 1308 may indicate the one or more actions performed to at least one subject of action 1310. For example, if the agent 1308 adjust parameters dynamically for processing (e.g., reordering, forwarding) of PDUs and/or SDUs, the agent 1308 may output an indication to the subject of action 1310 (such as, one or more protocol layers of the UE 115).

As another example, agent 1308 may be a UE 115 and output 1314 from model inference host 1304 one or more characteristics for processing (e.g., reordering, forwarding) of PDUs and/or SDUs. For example, model inference host 1304 may predict threshold values for the processing (e.g., reordering, forwarding) of PDUs and/or SDUs based on congestion levels. Based on the predicted threshold values, agent 1308, the UE 115, may adjust parameters dynamically for processing (e.g., reordering, forwarding) of PDUs and/or SDUs and output the adjusted parameters to the subject of action 1310 (such as, one or more protocol layers of the UE 115 as described with reference to FIG. 2).

Data can be collected from data sources 1306, and may be used as training data 1316 for training an ML model, or as inference data 1312 for feeding an ML model inference operation. Data sources 1306 may collect data from various subject of action 1310 entities (such as, the UE 115 or the network entity 105), and provide the collected data to a model training host 1302 for ML model training. For example, after a subject of action 1310 (such as, a UE 115) obtains congestion levels from agent 1308, the subject of action 1310 may provide performance feedback associated with the congestion levels to the data sources 1306. The performance feedback may be used by the model training host 1302 for monitoring or evaluating the ML model performance. In some examples, if output 1314 provided to agent 1308 is inaccurate (or the accuracy is below an accuracy threshold), model training host 1302 may provide feedback to model inference host 1304 to modify or retrain the ML model used by model inference host 1304, such as via an ML model deployment update.

Model training host 1302 may be deployed at the same or a different entity than that in which model inference host 13104 is deployed. For example, in order to offload model training processing, which can impact the performance of model inference host 1304, model training host 1302 may be deployed at a model server.

In some aspects, an ML model is deployed at or on a network entity (such as a base station 140 or a network entity 105) for processing (e.g., reordering, forwarding) of PDUs and/or SDUs. More specifically, a model interference host, such as model inference host 1304 in FIG. 13, may be deployed at or on the network entity 105 for such processing (e.g., reordering, forwarding) of PDUs and/or SDUs.

In some other aspects, an ML model is deployed at or on a UE (such as UE 115) for processing (e.g., reordering, forwarding) of PDUs and/or SDUs. More specifically, a model inference host, such as model inference host 1304 in FIG. 13, may be deployed at or on the UE for processing (e.g., reordering, forwarding) of PDUs and/or SDUs.

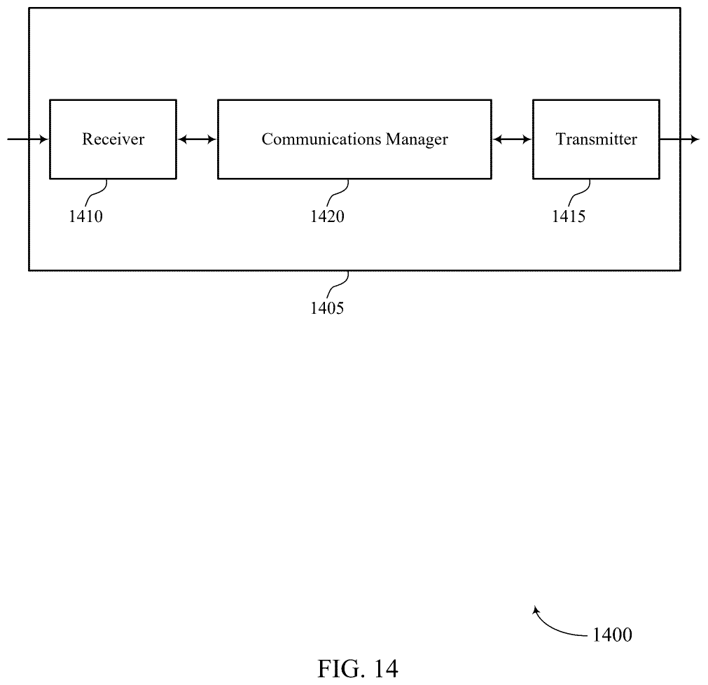

FIG. 14 shows a block diagram 1400 of a device 1405 that supports AI-enabled reordering in accordance with one or more aspects of the present disclosure. The device 1405 may be an example of aspects of a network entity 105, a UE 115, or a base station 140 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to, individually or collectively, support or enable the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to AI-enabled reordering). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to AI-enabled reordering). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations or components thereof may be examples of means for performing various aspects of AI-enabled reordering as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor (e.g., referred to as a processor-executable code). If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. For example, the communications manager 1420 is capable of, configured to, or operable to support a means for receiving control signaling indicating a configuration including a first set of one or more parameters associated with a reordering timer for a PDCP entity of the device 1405, and where the reordering timer is associated with reordering of a set of SDUs by the PDCP entity of the device 1405, where at least one parameter of the first set of one or more parameters includes a set of multiple values. The communications manager 1420 is capable of, configured to, or operable to support a means for determining a duration for the reordering timer according to the first set of one or more parameters associated with the reordering timer and based on a loss of at least one SDU of the set of SDUs, where the duration is based on a value of the set of multiple values. The communications manager 1420 is capable of, configured to, or operable to support a means for forwarding one or more SDUs of the set of SDUs based on an expiry of the reordering timer.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for adjusting a reordering timer, which may improve communication throughput, reduce memory or power utilization while reordering packets, or a combination thereof.

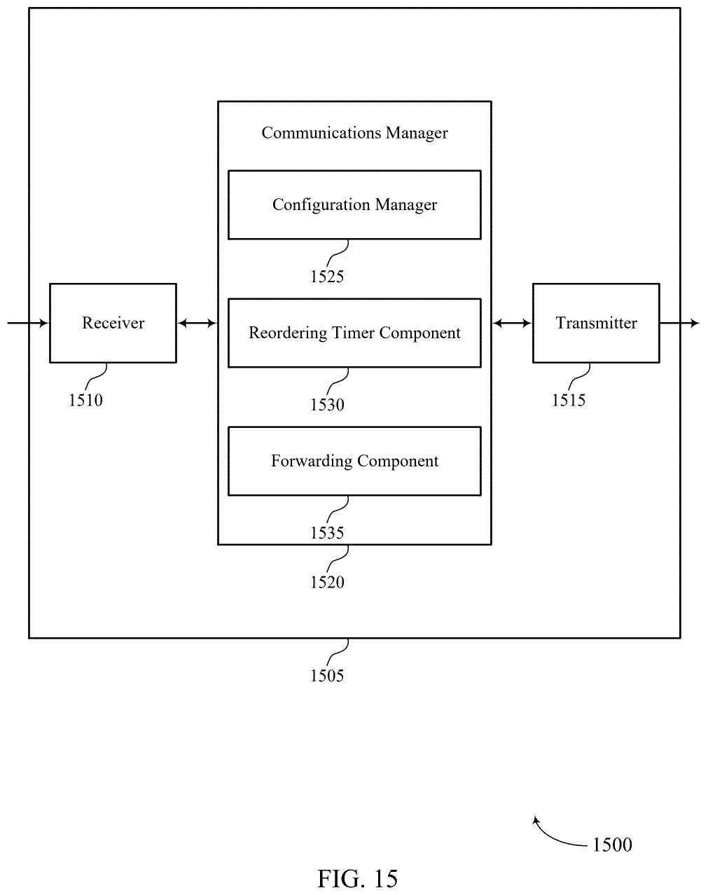

FIG. 15 shows a block diagram 1500 of a device 1505 that supports AI-enabled reordering in accordance with one or more aspects of the present disclosure. The device 1505 may be an example of aspects of a device 1405, a network entity 105, a UE 115, or a base station 140 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to support the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to AI-enabled reordering). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to AI-enabled reordering). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of AI-enabled reordering as described herein. For example, the communications manager 1520 may include a configuration manager 1525, a reordering timer component 1530, a forwarding component 1535, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. The configuration manager 1525 is capable of, configured to, or operable to support a means for receiving control signaling indicating a configuration including a first set of one or more parameters associated with a reordering timer for a PDCP entity of the device 1505, and where the reordering timer is associated with reordering of a set of SDUs by the PDCP entity of the device 1505, where at least one parameter of the first set of one or more parameters includes a set of multiple values. The reordering timer component 1530 is capable of, configured to, or operable to support a means for determining a duration for the reordering timer according to the first set of one or more parameters associated with the reordering timer and based on a loss of at least one SDU of the set of SDUs, where the duration is based on a value of the set of multiple values. The forwarding component 1535 is capable of, configured to, or operable to support a means for forwarding one or more SDUs of the set of SDUs based on an expiration of the reordering timer.

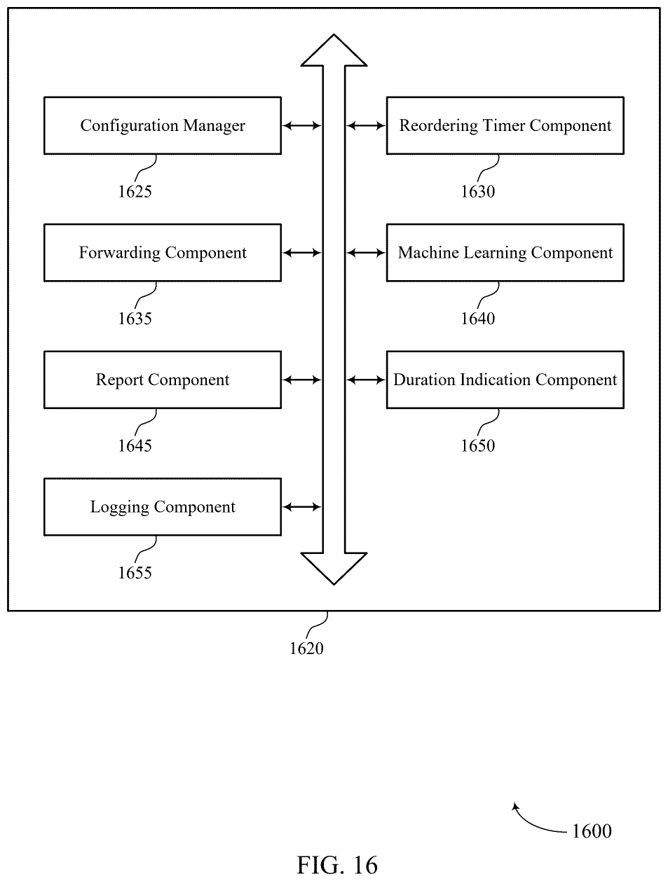

FIG. 16 shows a block diagram 1600 of a communications manager 1620 that supports AI-enabled reordering in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of AI-enabled reordering as described herein. For example, the communications manager 1620 may include a configuration manager 1625, a reordering timer component 1630, a forwarding component 1635, a ML component 1640, a report component 1645, a duration indication component 1650, a logging component 1655, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications in accordance with examples as disclosed herein. The configuration manager 1625 is capable of, configured to, or operable to support a means for receiving control signaling indicating a configuration including a first set of one or more parameters associated with a reordering timer for a PDCP entity of a wireless device, and where the reordering timer is associated with reordering of a set of SDUs by the PDCP entity of the wireless device, where at least one parameter of the first set of one or more parameters includes a set of multiple values. The reordering timer component 1630 is capable of, configured to, or operable to support a means for determining a duration for the reordering timer according to the first set of one or more parameters associated with the reordering timer and based on a loss of at least one SDU of the set of SDUs, where the duration is based on a value of the set of multiple values. The forwarding component 1635 is capable of, configured to, or operable to support a means for forwarding one or more SDUs of the set of SDUs based on an expiration of the reordering timer.

In some examples, the ML component 1640 is capable of, configured to, or operable to support a means for determining the duration for the reordering timer according to a learning model associated with the PDCP entity of the wireless device, where an input to the learning model includes one or more of the first set of one or more parameters or a second set of one or more parameters, where a value of the duration for the reordering timer includes an output of the learning model.

In some examples, the duration indication component 1650 is capable of, configured to, or operable to support a means for transmitting, to a second wireless device, an RRC message including an indication of the determined duration for the reordering timer according to the learning model, where the RRC message includes assistance information, and where the assistance information includes the indication of the determined duration for the reordering timer according to the learning model. In some examples, the duration indication component 1650 is capable of, configured to, or operable to support a means for transmitting, to the second wireless device, a medium access control-control element (MAC-CE) including the indication of the determined duration for the reordering timer according to the learning model. In some examples, the duration indication component 1650 is capable of, configured to, or operable to support a means for transmitting, to the second wireless device, a control PDU including the indication of the determined duration for the reordering timer according to the learning model. In some examples, the duration indication component 1650 is capable of, configured to, or operable to support a means for transmitting, to the second wireless device, a PDCP in-band signal including the indication of the determined duration for the reordering timer according to the learning model.

In some examples, the ML component 1640 is capable of, configured to, or operable to support a means for generating at least one PDU including an indication of the determined duration for the reordering timer according to the learning model. In some examples, the duration indication component 1650 is capable of, configured to, or operable to support a means for outputting, to a second wireless device via the PDCP entity of the wireless device, the at least one PDU including the indication of the determined duration for the reordering timer according to the learning model, where the at least one PDU includes a PDCP data PDU or a PDCP control PDU, and where the second wireless device includes a UE or a network entity, including a base station or a server associated with the learning model.

In some examples, the duration indication component 1650 is capable of, configured to, or operable to support a means for receiving, from a second wireless device, HARQ feedback, where the HARQ feedback includes at least one ACK or NACK associated with the determined duration for the reordering timer according to the learning model, where the second wireless device includes a UE or a network entity, including a base station or a server associated with the learning model.

In some examples, the logging component 1655 is capable of, configured to, or operable to support a means for storing a set of one or more logs associated with the learning model, where at least one log of the set of one or more logs includes a set of previous durations of the reordering timer, where the input to the learning model includes the set of previous durations of the reordering timer, where determining the duration for the reordering timer according to the learning model is based on the input to the learning model includes the set of previous durations of the reordering timer.

In some examples, the logging component 1655 is capable of, configured to, or operable to support a means for transmitting, to a second wireless device, a report including the set of one or more logs associated with the learning model, where at least one second log of the set of one or more logs associated with the learning model includes a set of performance metrics associated with the learning model for the set of previous durations of the reordering timer, where the second wireless device include a UE or a network entity, including a base station or a server associated with the learning model.

In some examples, the report component 1645 is capable of, configured to, or operable to support a means for transmitting, to a second wireless device, a report including capability information that indicates whether the wireless device supports a learning model associated with the reordering timer for the PDCP entity of the wireless device, a quality metric associated with the learning model, or both, where the capability information further indicates whether the wireless device supports one or more of prediction of a set of arrival times of the set of SDUs according to the learning model or reporting of an accuracy of the learning model for the prediction of the set of arrival times of the set of SDUs, where the second wireless device include a UE or a network entity, including a base station or a server associated with the learning model, where receiving the control signaling indicating the configuration including the first set of one or more parameters associated with the reordering timer for the PDCP entity of the wireless device is based on the capability information.

In some examples, the one or more parameters may include at least one first parameter that indicates a first threshold value associated with the reordering timer, at least one second parameter that indicates a second threshold value associated with the reordering timer, at least one third parameter that indicates a threshold quantity of SDUs of the set of SDUs allowed for forwarding by the PDCP entity of the wireless device, at least one fourth parameter that indicates whether the reordering timer is configurable for counting the threshold quantity of SDUs of the set of SDUs allowed for forwarding by the PDCP entity of the wireless device, at least one fifth parameter that indicates whether a learning model is enabled or disabled for the PDCP entity of the wireless device, or at least one sixth parameter that indicates whether reordering of the set of SDUs is based on a QoS flow and whether the learning model is enabled or disabled for the QoS flow.

In some examples, the configuration is associated with one or more of a QoS flow, a primary cell associated with the wireless device, a secondary cell associated with the wireless device, a logical channel associated with the PDCP entity of the wireless device, or a component carrier associated with the wireless device.

In some examples, the configuration includes a second set of one or more parameters associated with a learning model associated with the reordering timer for the PDCP entity of the wireless device. In some examples, a performance target of the learning model is based on the second set of one or more parameters.

In some examples, the ML component 1640 is capable of, configured to, or operable to support a means for determining a failure of the learning model to satisfy at least one parameter of the second set of one or more parameters. In some examples, the reordering timer component 1630 is capable of, configured to, or operable to support a means for updating the duration of the reordering timer according to the at least one parameter that indicates a second threshold value associated with the reordering timer, based on the failure of the learning model to satisfy the at least one parameter of the second set of one or more parameters.

In some examples, the report component 1645 is capable of, configured to, or operable to support a means for transmitting, to a second wireless device, a report including an indication of a performance of the learning model to satisfy at least one parameter of the second set of one or more parameters, where the second wireless device include a network entity, including a base station or a server associated with the learning model. In some examples, the ML component 1640 is capable of, configured to, or operable to support a means for disabling the learning model based on the failure of the learning model to satisfy at least one parameter of the second set of one or more parameters.

In some examples, the report component 1645 is capable of, configured to, or operable to support a means for receiving, from a second wireless device, a report including an indication of a performance of the learning model, where the second wireless device include a network entity, including a base station or a server associated with the learning model.

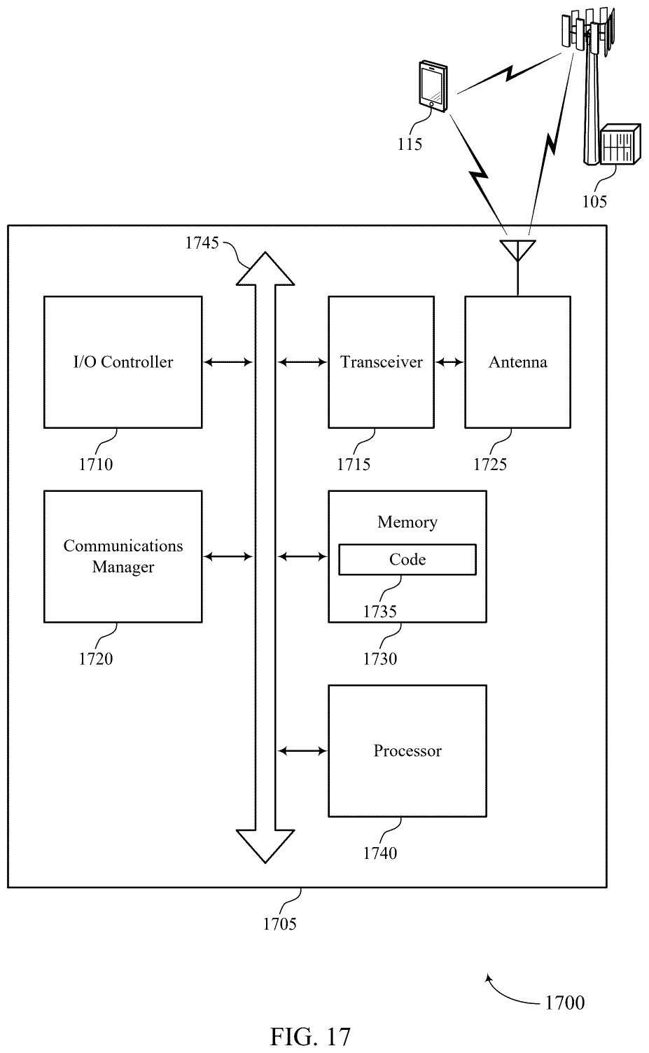

FIG. 17 shows a diagram of a system 1700 including a device 1705 that supports AI-enabled reordering in accordance with one or more aspects of the present disclosure. The device 1705 may be an example of or include components of a device 1405, a device 1505, or a UE 115 as described herein. The device 1705 may communicate (e.g., wirelessly) with one or more other devices (e.g., network entities 105, UEs 115, or a combination thereof). The device 1705 may include components for bi-directional voice and data communications including components for transmitting and receiving communications, such as a communications manager 1720, an input/output (I/O) controller, such as an I/O controller 1710, a transceiver 1715, one or more antennas 1725, at least one memory 1730, code 1735, and at least one processor 1740. These components may be in electronic communication or otherwise coupled (e.g., operatively, communicatively, functionally, electronically, electrically) via one or more buses (e.g., a bus 1745).

The I/O controller 1710 may manage input and output signals for the device 1705. The I/O controller 1710 may also manage peripherals not integrated into the device 1705. In some cases, the I/O controller 1710 may represent a physical connection or port to an external peripheral. In some cases, the I/O controller 1710 may utilize an operating system such as iOS®, ANDROID®, MS-DOS®, MS-WINDOWS®, OS/2®, UNIX®, LINUX®, or another known operating system. Additionally, or alternatively, the I/O controller 1710 may represent or interact with a modem, a keyboard, a mouse, a touchscreen, or a similar device. In some cases, the I/O controller 1710 may be implemented as part of one or more processors, such as the at least one processor 1740. In some cases, a user may interact with the device 1705 via the I/O controller 1710 or via hardware components controlled by the I/O controller 1710.

In some cases, the device 1705 may include a single antenna. However, in some other cases, the device 1705 may have more than one antenna, which may be capable of concurrently transmitting or receiving multiple wireless transmissions. The transceiver 1715 may communicate bi-directionally via the one or more antennas 1725 using wired or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The at least one memory 1730 may include random access memory (RAM) and read-only memory (ROM). The at least one memory 1730 may store computer-readable, computer-executable, or processor-executable code, such as the code 1735. The code 1735 may include instructions that, when executed by the at least one processor 1740, cause the device 1705 to perform various functions described herein. The code 1735 may be stored in a non-transitory computer-readable medium such as system memory or another type of memory. In some cases, the code 1735 may not be directly executable by the at least one processor 1740 but may cause a computer (e.g., when compiled and executed) to perform functions described herein. In some cases, the at least one memory 1730 may include, among other things, a basic I/O system (BIOS) which may control basic hardware or software operation such as the interaction with peripheral components or devices.

The at least one processor 1740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1740 may be configured to operate a memory array using a memory controller. In some other cases, a memory controller may be integrated into the at least one processor 1740. The at least one processor 1740 may be configured to execute computer-readable instructions stored in a memory (e.g., the at least one memory 1730) to cause the device 1705 to perform various functions (e.g., functions or tasks supporting AI-enabled reordering). For example, the device 1705 or a component of the device 1705 may include at least one processor 1740 and at least one memory 1730 coupled with or to the at least one processor 1740, the at least one processor 1740 and the at least one memory 1730 configured to perform various functions described herein.

In some examples, the at least one processor 1740 may include multiple processors and the at least one memory 1730 may include multiple memories. One or more of the multiple processors may be coupled with one or more of the multiple memories, which may, individually or collectively, be configured to perform various functions described herein. In some examples, the at least one processor 1740 may be a component of a processing system, which may refer to a system (such as a series) of machines, circuitry (including, for example, one or both of processor circuitry (which may include the at least one processor 1740) and memory circuitry (which may include the at least one memory 1730)), or components, that receives or obtains inputs and processes the inputs to produce, generate, or obtain a set of outputs. The processing system may be configured to perform one or more of the functions described herein. For example, the at least one processor 1740 or a processing system including the at least one processor 1740 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code 1735 (e.g., processor-executable code) stored in the at least one memory 1730 or otherwise, to perform one or more of the functions described herein.

The communications manager 1720 may support wireless communications in accordance with examples as disclosed herein. For example, the communications manager 1720 is capable of, configured to, or operable to support a means for receiving control signaling indicating a configuration including a first set of one or more parameters associated with a reordering timer for a PDCP entity of the device 1705, and where the reordering timer is associated with reordering of a set of SDUs by the PDCP entity of the device 1705, where at least one parameter of the first set of one or more parameters includes a set of multiple values. The communications manager 1720 is capable of, configured to, or operable to support a means for determining a duration for the reordering timer according to the first set of one or more parameters associated with the reordering timer and based on a loss of at least one SDU of the set of SDUs, where the duration is based on a value of the set of multiple values. The communications manager 1720 is capable of, configured to, or operable to support a means for forwarding one or more SDUs of the set of SDUs based on an expiration of the reordering timer.

By including or configuring the communications manager 1720 in accordance with examples as described herein, the device 1705 may support techniques for adjusting a reordering timer, which may improve communication throughput, reduce memory or power utilization while reordering packets, or a combination thereof. Accordingly, device battery life and responsiveness may improve, and the user experience may be enhanced.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the at least one processor 1740, the at least one memory 1730, the code 1735, or any combination thereof. For example, the code 1735 may include instructions executable by the at least one processor 1740 to cause the device 1705 to perform various aspects of AI-enabled reordering as described herein, or the at least one processor 1740 and the at least one memory 1730 may be otherwise configured to, individually or collectively, perform or support such operations.

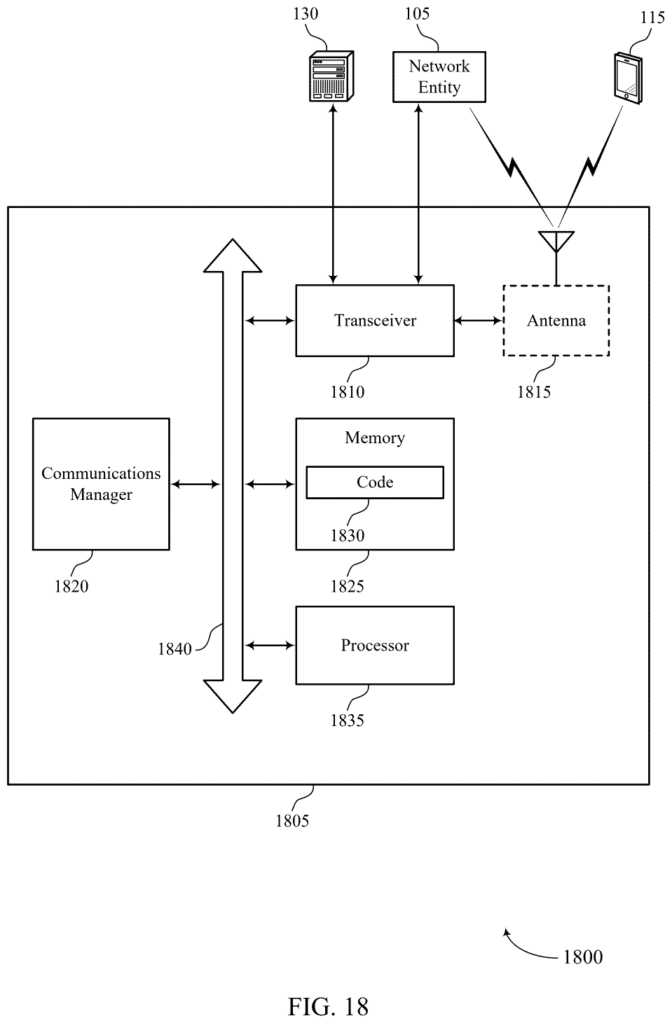

FIG. 18 shows a diagram of a system 1800 including a device 1805 that supports AI-enabled reordering in accordance with one or more aspects of the present disclosure. The device 1805 may be an example of or include components of a device 1405, a device 1505, or a network entity 105 as described herein. The device 1805 may communicate with other network devices or network equipment such as one or more of the network entities 105, UEs 115, or any combination thereof. The communications may include communications over one or more wired interfaces, over one or more wireless interfaces, or any combination thereof. The device 1805 may include components that support outputting and obtaining communications, such as a communications manager 1820, a transceiver 1810, one or more antennas 1815, at least one memory 1825, code 1830, and at least one processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or one or more memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or one or more memory components (e.g., the at least one processor 1835, the at least one memory 1825, or both), may be included in a chip or chip assembly that is installed in the device 1805. In some examples, the transceiver 1810 may be operable to support communications via one or more communications links (e.g., communication link(s) 125, backhaul communication link(s) 120, a midhaul communication link 162, a fronthaul communication link 168).

The at least one memory 1825 may include RAM, ROM, or any combination thereof. The at least one memory 1825 may store computer-readable, computer-executable, or processor-executable code, such as the code 1830. The code 1830 may include instructions that, when executed by one or more of the at least one processor 1835, cause the device 1805 to perform various functions described herein. The code 1830 may be stored in a non-transitory computer-readable medium such as system memory or another type of memory. In some cases, the code 1830 may not be directly executable by a processor of the at least one processor 1835 but may cause a computer (e.g., when compiled and executed) to perform functions described herein. In some cases, the at least one memory 1825 may include, among other things, a BIOS which may control basic hardware or software operation such as the interaction with peripheral components or devices. In some examples, the at least one processor 1835 may include multiple processors and the at least one memory 1825 may include multiple memories. One or more of the multiple processors may be coupled with one or more of the multiple memories which may, individually or collectively, be configured to perform various functions herein (for example, as part of a processing system).

The at least one processor 1835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1835 may be configured to operate a memory array using a memory controller. In some other cases, a memory controller may be integrated into one or more of the at least one processor 1835. The at least one processor 1835 may be configured to execute computer-readable instructions stored in a memory (e.g., one or more of the at least one memory 1825) to cause the device 1805 to perform various functions (e.g., functions or tasks supporting AI-enabled reordering). For example, the device 1805 or a component of the device 1805 may include at least one processor 1835 and at least one memory 1825 coupled with one or more of the at least one processor 1835, the at least one processor 1835 and the at least one memory 1825 configured to perform various functions described herein. The at least one processor 1835 may be an example of a cloud-computing platform (e.g., one or more physical nodes and supporting software such as operating systems, virtual machines, or container instances) that may host the functions (e.g., by executing code 1830) to perform the functions of the device 1805. The at least one processor 1835 may be any one or more suitable processors capable of executing scripts or instructions of one or more software programs stored in the device 1805 (such as within one or more of the at least one memory 1825).

In some examples, the at least one processor 1835 may include multiple processors and the at least one memory 1825 may include multiple memories. One or more of the multiple processors may be coupled with one or more of the multiple memories, which may, individually or collectively, be configured to perform various functions herein. In some examples, the at least one processor 1835 may be a component of a processing system, which may refer to a system (such as a series) of machines, circuitry (including, for example, one or both of processor circuitry (which may include the at least one processor 1835) and memory circuitry (which may include the at least one memory 1825)), or components, that receives or obtains inputs and processes the inputs to produce, generate, or obtain a set of outputs. The processing system may be configured to perform one or more of the functions described herein. For example, the at least one processor 1835 or a processing system including the at least one processor 1835 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1825 or otherwise, to perform one or more of the functions described herein.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the at least one memory 1825, the code 1830, and the at least one processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with one or more other network entities 105, and may include a controller or scheduler for controlling communications with UEs 115 (e.g., in cooperation with the one or more other network devices). In some examples, the communications manager 1820 may support an X2 interface within an LTE/LTE-A wireless communications network technology to provide communication between network entities 105.

The communications manager 1820 may support wireless communications in accordance with examples as disclosed herein. For example, the communications manager 1820 is capable of, configured to, or operable to support a means for receiving control signaling indicating a configuration including a first set of one or more parameters associated with a reordering timer for a PDCP entity of the device 1805, and where the reordering timer is associated with reordering of a set of SDUs by the PDCP entity of the device 1805, where at least one parameter of the first set of one or more parameters includes a set of multiple values. The communications manager 1820 is capable of, configured to, or operable to support a means for determining a duration for the reordering timer according to the first set of one or more parameters associated with the reordering timer and based on a loss of at least one SDU of the set of SDUs, where the duration is based on a value of the set of multiple values. The communications manager 1820 is capable of, configured to, or operable to support a means for forwarding one or more SDUs of the set of SDUs based on an expiration of the reordering timer.

By including or configuring the communications manager 1820 in accordance with examples as described herein, the device 1805 may support techniques for adjusting a reordering timer, which may improve communication throughput, reduce memory or power utilization while reordering packets, or a combination thereof.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, one or more of the at least one processor 1835, one or more of the at least one memory 1825, the code 1830, or any combination thereof (for example, by a processing system including at least a portion of the at least one processor 1835, the at least one memory 1825, the code 1830, or any combination thereof). For example, the code 1830 may include instructions executable by one or more of the at least one processor 1835 to cause the device 1805 to perform various aspects of AI-enabled reordering as described herein, or the at least one processor 1835 and the at least one memory 1825 may be otherwise configured to, individually or collectively, perform or support such operations.

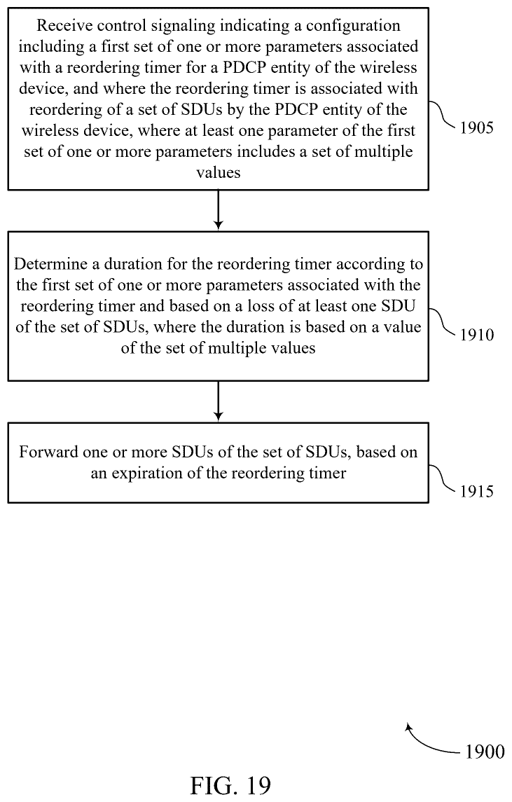

FIG. 19 shows a flowchart illustrating a method 1900 that supports AI-enabled reordering in accordance with one or more aspects of the present disclosure. The operations of the method 1900 may be implemented by a wireless device, such as a network entity, a UE, or a base station, or its components as described herein. For example, the operations of the method 1900 may be performed by a network entity 105, a UE 115, or a base station 140 as described with reference to FIGS. 1 through 18. In some examples, the network entity 105, the UE 115, or the base station 140 may execute a set of instructions to control the functional elements of the network entity 105, the UE 115, or the base station 140 to perform the described functions. Additionally, or alternatively, the network entity 105, the UE 115, or the base station 140 may perform aspects of the described functions using special-purpose hardware.

At 1905, the method may include receiving control signaling indicating a configuration including a first set of one or more parameters associated with a reordering timer for a PDCP entity of the wireless device, and where the reordering timer is associated with reordering of a set of SDUs by the PDCP entity of the wireless device, where at least one parameter of the first set of one or more parameters includes a set of multiple values. The operations of 1905 may be performed in accordance with examples as disclosed herein. In some examples, aspects of the operations of 1905 may be performed by a configuration manager 1625 as described with reference to FIG. 16.

At 1910, the method may include determining a duration for the reordering timer according to the first set of one or more parameters associated with the reordering timer and based on a loss of at least one SDU of the set of SDUs, where the duration corresponds a value of the set of multiple values. The operations of 1910 may be performed in accordance with examples as disclosed herein. In some examples, aspects of the operations of 1910 may be performed by a reordering timer component 1630 as described with reference to FIG. 16.

At 1915, the method may include processing the set of SDUs, by forwarding one or more SDUs of the set of SDUs, based on an expiration of the reordering timer. The operations of 1915 may be performed in accordance with examples as disclosed herein. In some examples, aspects of the operations of 1915 may be performed by a forwarding component 1635 as described with reference to FIG. 16.

The following provides an overview of aspects of the present disclosure:

Aspect 1: A method for wireless communications by a wireless device, comprising: receiving control signaling indicating a configuration comprising a first set of one or more parameters associated with a reordering timer for a PDCP entity of the wireless device, and wherein the reordering timer is associated with reordering of a set of SDUs by the PDCP entity of the wireless device, wherein at least one parameter of the first set of one or more parameters comprises a plurality of values; determining a duration for the reordering timer according to the first set of one or more parameters associated with the reordering timer and based at least in part on a loss of at least one

SDU of the set of SDUs, wherein the duration is based on a value of the plurality of values; and forwarding one or more SDUs of the set of SDUs based at least in part on a expiration of the reordering timer.

Aspect 2: The method of aspect 1, further comprising: determining the duration for the reordering timer according to a learning model associated with the PDCP entity of the wireless device, wherein an input to the learning model comprises one or more of the first set of one or more parameters or a second set of one or more parameters, wherein a value of the duration for the reordering timer comprises an output of the learning model.

Aspect 3: The method of aspect 2, further comprising: transmitting, to a second wireless device, a radio resource control message comprising an indication of the determined duration for the reordering timer according to the learning model, wherein the radio resource control message comprises assistance information, and wherein the assistance information includes the indication of the determined duration for the reordering timer according to the learning model; transmitting, to the second wireless device, a medium access control-control element comprising the indication of the determined duration for the reordering timer according to the learning model; transmitting, to the second wireless device, a control PDU comprising the indication of the determined duration for the reordering timer according to the learning model; or transmitting, to the second wireless device, a PDCP in-band signal comprising the indication of the determined duration for the reordering timer according to the learning model, wherein the second wireless device comprises a UE or a network entity, including a base station or a server associated with the learning model.

Aspect 4: The method of any of aspects 2 through 3, further comprising: generating at least one PDU comprising an indication of the determined duration for the reordering timer according to the learning model; and outputting, to a second wireless device via the PDCP entity of the wireless device, the at least one PDU comprising the indication of the determined duration for the reordering timer according to the learning model, wherein the at least one PDU comprises a PDCP data PDU or a PDCP control PDU, and wherein the second wireless device comprises a UE or a network entity, including a base station or a server associated with the learning model.

Aspect 5: The method of aspect 2, further comprising: receiving, from a second wireless device, HARQ feedback, wherein the HARQ feedback comprises at least one ACK or NACK associated with the determined duration for the reordering timer according to the learning model, wherein the second wireless device comprise a UE or a network entity, including a base station or a server associated with the learning model.

Aspect 6: The method of any of aspects 2 through 5, further comprising: storing a set of one or more logs associated with the learning model, wherein at least one log of the set of one or more logs comprises a set of previous durations of the reordering timer, wherein the input to the learning model comprises the set of previous durations of the reordering timer, wherein determining the duration for the reordering timer according to the learning model is based at least in part on the input to the learning model comprises the set of previous durations of the reordering timer.

Aspect 7: The method of aspect 6, further comprising: transmitting, to a second wireless device, a report comprising the set of one or more logs associated with the learning model, wherein at least one second log of the set of one or more logs associated with the learning model comprises a set of performance metrics associated with the learning model for the set of previous durations of the reordering timer, wherein the second wireless device comprise a UE or a network entity, including a base station or a server associated with the learning model.

Aspect 8: The method of aspect 1, further comprising: transmitting, to a second wireless device, a report comprising capability information that indicates whether the wireless device supports a learning model associated with the reordering timer for the PDCP entity of the wireless device, a quality metric associated with the learning model, or both, wherein the capability information further indicates whether the wireless device supports one or more of prediction of a set of arrival times of the set of SDUs according to the learning model or reporting of an accuracy of the learning model for the prediction of the set of arrival times of the set of SDUs, wherein the second wireless device comprise a UE or a network entity, including a base station or a server associated with the learning model, wherein receiving the control signaling indicating the configuration comprising the first set of one or more parameters associated with the reordering timer for the PDCP entity of the wireless device is based at least in part on the capability information.

Aspect 9: The method of any of aspects 1 through 8, wherein the first set of one or more parameters comprises one or more of: at least one first parameter that indicates a first threshold value associated with the reordering timer, at least one second parameter that indicates a second threshold value associated with the reordering timer, at least one third parameter that indicates a threshold quantity of SDUs of the set of SDUs allowed for forwarding by the PDCP entity of the wireless device, at least one fourth parameter that indicates whether the reordering timer is configurable for counting the threshold quantity of SDUs of the set of SDUs allowed for forwarding by the PDCP entity of the wireless device, at least one fifth parameter that indicates whether a learning model is enabled or disabled for the PDCP entity of the wireless device, or at least one sixth parameter that indicates whether reordering of the set of SDUs is based at least in part on a QoS flow and whether the learning model is enabled or disabled for the QoS flow.

Aspect 10: The method of any of aspects 1 through 9, wherein the configuration is associated with one or more of a QoS flow, a primary cell associated with the wireless device, a secondary cell associated with the wireless device, a logical channel associated with the PDCP entity of the wireless device, or a component carrier associated with the wireless device.

Aspect 11: The method of any of aspects 1 through 10, wherein the configuration comprises a second set of one or more parameters associated with a learning model associated with the reordering timer for the PDCP entity of the wireless device, and a performance target of the learning model is based at least in part on the second set of one or more parameters.

Aspect 12: The method of aspect 11, further comprising: determining a failure of the learning model to satisfy at least one parameter of the second set of one or more parameters; and updating the duration of the reordering timer according to the at least one parameter that indicates a second threshold value associated with the reordering timer, based at least in part on the failure of the learning model to satisfy the at least one parameter of the second set of one or more parameters.

Aspect 13: The method of aspect 12, further comprising: transmitting, to a second wireless device, a report comprising an indication of a performance of the learning model to satisfy at least one parameter of the second set of one or more parameters, wherein the second wireless device comprise a network entity, including a base station or a server associated with the learning model; and disabling the learning model based at least in part on the failure of the learning model to satisfy at least one parameter of the second set of one or more parameters.

Aspect 14: The method of any of aspects 11 through 13, further comprising: receiving, from a second wireless device, a report comprising an indication of a performance of the learning model, wherein the second wireless device comprise a network entity, including a base station or a server associated with the learning model.

Aspect 15: A wireless device for wireless communications, comprising one or more memories storing processor-executable code, and one or more processors coupled with the one or more memories and individually or collectively operable to execute the code to cause the wireless device to perform a method of any of aspects 1 through 14.

Aspect 16: A wireless device for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive control signaling indicating a configuration comprising a first set of one or more parameters associated with a reordering timer for a packet data convergence protocol entity of the wireless device, wherein the reordering timer is associated with reordering of a set of service data units by the packet data convergence protocol entity of the wireless device, and wherein at least one parameter of the first set of one or more parameters comprises a plurality of values;
determine a duration for the reordering timer according to the first set of one or more parameters associated with the reordering timer and based at least in part on a loss of at least one service data unit of the set of service data units, wherein the duration is based on a value of the plurality of values; and
forward one or more service data units of the set of service data units based at least in part on an expiration of the reordering timer.

2. The wireless device of claim 1, wherein the one or more processors are individually or collectively further operable to execute the code to cause the wireless device to:
determine the duration for the reordering timer according to a learning model associated with the packet data convergence protocol entity of the wireless device, wherein an input to the learning model comprises one or more of the first set of one or more parameters or a second set of one or more parameters, wherein a value of the duration for the reordering timer comprises an output of the learning model.

3. The wireless device of claim 2, wherein the one or more processors are individually or collectively further operable to execute the code to cause the wireless device to:
transmit, to a second wireless device, a radio resource control message comprising an indication of the determined duration for the reordering timer according to the learning model, wherein the radio resource control message comprises assistance information, and wherein the assistance information includes the indication of the determined duration for the reordering timer according to the learning model;
transmit, to the second wireless device, a medium access control-control element comprising the indication of the determined duration for the reordering timer according to the learning model;
transmit, to the second wireless device, a control protocol data unit comprising the indication of the determined duration for the reordering timer according to the learning model; or
transmit, to the second wireless device, a packet data convergence protocol in-band signal comprising the indication of the determined duration for the reordering timer according to the learning model,
wherein the second wireless device comprise a user equipment (UE) or a network entity, including a base station or a server associated with the learning model.

4. The wireless device of claim 2, wherein the one or more processors are individually or collectively further operable to execute the code to cause the wireless device to:
generate at least one protocol data unit comprising an indication of the determined duration for the reordering timer according to the learning model; and
output, to a second wireless device via the packet data convergence protocol entity of the wireless device, the at least one protocol data unit comprising the indication of the determined duration for the reordering timer according to the learning model,
wherein the at least one protocol data unit comprises a packet data convergence protocol data protocol data unit or a packet data convergence protocol control protocol data unit, and
wherein the second wireless device comprise a user equipment (UE) or a network entity, including a base station or a server associated with the learning model.

5. The wireless device of claim 2, wherein the one or more processors are individually or collectively further operable to execute the code to cause the wireless device to:
receive, from a second wireless device, hybrid automatic repeat request feedback, wherein the hybrid automatic repeat request feedback comprises at least one acknowledgment or negative acknowledgment associated with the determined duration for the reordering timer according to the learning model,
wherein the second wireless device comprises a user equipment (UE) or a network entity, including a base station or a server associated with the learning model.

6. The wireless device of claim 2, wherein the one or more processors are individually or collectively further operable to execute the code to cause the wireless device to:
store a set of one or more logs associated with the learning model, wherein at least one log of the set of one or more logs comprises a set of previous durations of the reordering timer, wherein the input to the learning model comprises the set of previous durations of the reordering timer,
wherein the duration for the reordering timer is determined based at least in part on the input to the learning model comprising the set of previous durations of the reordering timer.

7. The wireless device of claim 6, wherein the one or more processors are individually or collectively further operable to execute the code to cause the wireless device to:
transmit, to a second wireless device, a report comprising the set of one or more logs associated with the learning model,
wherein at least one second log of the set of one or more logs associated with the learning model comprises a set of performance metrics associated with the learning model for the set of previous durations of the reordering timer,
wherein the second wireless device comprises a user equipment (UE) or a network entity, including a base station or a server associated with the learning model.

8. The wireless device of claim 1, wherein the one or more processors are individually or collectively further operable to execute the code to cause the wireless device to:
transmit, to a second wireless device, a report comprising capability information that indicates whether the wireless device supports a learning model associated with the reordering timer for the packet data convergence protocol entity of the wireless device, a quality metric associated with the learning model, or both,
wherein the capability information further indicates whether the wireless device supports one or more of prediction of a set of arrival times of the set of service data units according to the learning model or reporting of an accuracy of the learning model for the prediction of the set of arrival times of the set of service data units,
wherein the second wireless device comprise a user equipment (UE) or a network entity, including a base station or a server associated with the learning model,
wherein the control signaling is received based at least in part on the capability information.

9. The wireless device of claim 1, wherein the first set of one or more parameters comprises one or more of:
at least one first parameter that indicates a first threshold value associated with the reordering timer, at least one second parameter that indicates a second threshold value associated with the reordering timer, at least one third parameter that indicates a threshold quantity of service data units of the set of service data units allowed for forwarding by the packet data convergence protocol entity of the wireless device, at least one fourth parameter that indicates whether the reordering timer is configurable for counting the threshold quantity of service data units of the set of service data units allowed for forwarding by the packet data convergence protocol entity of the wireless device, at least one fifth parameter that indicates whether a learning model is enabled or disabled for the packet data convergence protocol entity of the wireless device, or at least one sixth parameter that indicates whether reordering of the set of service data units is based at least in part on a Quality-of-Service (QOS) flow and whether the learning model is enabled or disabled for the QoS flow.

10. The wireless device of claim 1, wherein the configuration is associated with one or more of a Quality-of-Service (QOS) flow, a primary cell associated with the wireless device, a secondary cell associated with the wireless device, a logical channel associated with the packet data convergence protocol entity of the wireless device, or a component carrier associated with the wireless device.

11. The wireless device of claim 1, wherein the configuration comprises a second set of one or more parameters associated with a learning model associated with the reordering timer for the packet data convergence protocol entity of the wireless device, and wherein a performance target of the learning model is based at least in part on the second set of one or more parameters.

12. The wireless device of claim 11, wherein the one or more processors are individually or collectively further operable to execute the code to cause the wireless device to:
determine a failure of the learning model to satisfy at least one parameter of the second set of one or more parameters; and
update the duration of the reordering timer according to the at least one parameter that indicates a second threshold value associated with the reordering timer, based at least in part on the failure of the learning model to satisfy the at least one parameter of the second set of one or more parameters.

13. The wireless device of claim 12, wherein the one or more processors are individually or collectively further operable to execute the code to cause the wireless device to:
transmit, to a second wireless device, a report comprising an indication of a performance of the learning model to satisfy at least one parameter of the second set of one or more parameters, wherein the second wireless device comprise a network entity, including a base station or a server associated with the learning model; and
disable the learning model based at least in part on the failure of the learning model to satisfy at least one parameter of the second set of one or more parameters.

14. The wireless device of claim 11, wherein the one or more processors are individually or collectively further operable to execute the code to cause the wireless device to:
receive, from a second wireless device, a report comprising an indication of a performance of the learning model, wherein the second wireless device comprise a network entity, including a base station or a server associated with the learning model.

15. A method for wireless communications by a wireless device, comprising:
receiving control signaling indicating a configuration comprising a first set of one or more parameters associated with a reordering timer for a packet data convergence protocol entity of the wireless device, wherein the reordering timer is associated with reordering of a set of service data units by the packet data convergence protocol entity of the wireless device, and wherein at least one parameter of the first set of one or more parameters comprises a plurality of values;
determining a duration for the reordering timer according to the first set of one or more parameters associated with the reordering timer and based at least in part on a loss of at least one service data unit of the set of service data units, wherein the duration is based on a value of the plurality of values; and
forwarding one or more service data units of the set of service data units based at least in part on an expiry of the reordering timer.

16. The method of claim 15, further comprising:
determining the duration for the reordering timer according to a learning model associated with the packet data convergence protocol entity of the wireless device, wherein an input to the learning model comprises one or more of the first set of one or more parameters or a second set of one or more parameters, wherein a value of the duration for the reordering timer comprises an output of the learning model.

17. The method of claim 16, further comprising:
transmitting, to a second wireless device, a radio resource control message comprising an indication of the determined duration for the reordering timer according to the learning model, wherein the radio resource control message comprises assistance information, and wherein the assistance information includes the indication of the determined duration for the reordering timer according to the learning model;
transmitting, to the second wireless device, a medium access control-control element comprising the indication of the determined duration for the reordering timer according to the learning model;
transmitting, to the second wireless device, a control protocol data unit comprising the indication of the determined duration for the reordering timer according to the learning model; or
transmitting, to the second wireless device, a packet data convergence protocol in-band signal comprising the indication of the determined duration for the reordering timer according to the learning model,
wherein the second wireless device comprise a user equipment (UE) or a network entity, including a base station or a server associated with the learning model.

18. The method of claim 16, further comprising:
generating at least one protocol data unit comprising an indication of the determined duration for the reordering timer according to the learning model; and
outputting, to a second wireless device via the packet data convergence protocol entity of the wireless device, the at least one protocol data unit comprising the indication of the determined duration for the reordering timer according to the learning model,
wherein the at least one protocol data unit comprises a packet data convergence protocol data protocol data unit or a packet data convergence protocol control protocol data unit, and
wherein the second wireless device comprise a user equipment (UE) or a network entity, including a base station or a server associated with the learning model.

19. The method of claim 16, further comprising:
receiving, from a second wireless device, hybrid automatic repeat request feedback, wherein the hybrid automatic repeat request feedback comprises at least one acknowledgment or negative acknowledgment associated with the determined duration for the reordering timer according to the learning model, wherein the second wireless device comprise a user equipment (UE) or a network entity, including a base station or a server associated with the learning model.

20. A non-transitory computer-readable medium storing code for wireless communications, the code comprising instructions executable by one or more processors to:
receive control signaling indicating a configuration comprising a first set of one or more parameters associated with a reordering timer for a packet data convergence protocol entity of a wireless device, wherein the reordering timer is associated with reordering of a set of service data units by the packet data convergence protocol entity of the wireless device, and wherein at least one parameter of the first set of one or more parameters comprises a plurality of values;
determine a duration for the reordering timer according to the first set of one or more parameters associated with the reordering timer and based at least in part on a loss of at least one service data unit of the set of service data units, wherein the duration is based on a value of the plurality of values; and
forward one or more service data units of the set of service data units based at least in part on an expiry of the reordering timer.
